(19) United States
(12) Patent Application Publication
(10) Pub. No.: US 2009/0320708 A1
(43) Pub. Date: Dec. 31, 2009

(54) RECORDING SHEET WITH IMPROVED PRINT DENSITY

(75) Inventors: John F. Jackson, Lebanon, OH (US); Krshna M. Pamidimukkala, Paramus, NJ (US); Joseph T. McCarthy, West Chester, OH (US)

Correspondence Address: INTERNATIONAL PAPER COMPANY, 6285 TRI-RIDGE BOULEVARD, LOVELAND, OH, 45140, US

(73) Assignee: INTERNATIONAL PAPER COMPANY, Memphis, TN (US)

(21) Appl. No.: 12/492,585

(22) Filed: Jun. 26, 2009

Related U.S. Application Data
(60) Provisional application No. 61/133,235, filed on Jun. 26, 2008.

(51) Int. Cl. B41F 33/00

(52) U.S. Cl. 101/483

(57) ABSTRACT

This invention is directed to a composition that, when applied to a cellulosic substrate, provides a recording media that has enhanced print density for cyan, magenta and black flexographic printing inks, as well as methods of using and making the composition and media. Also, the present invention relates to a method of achieving enhanced print density with flexographic printing ink compositions at reduced concentrations.

### RELATED PATENT APPLICATION

This is a non-provisional application which claims priority from U.S. Provisional Patent Application Ser. No. 61/133,235 filed on Jun. 26, 2008.

### FIELD OF THE INVENTION

This invention is directed to a composition that, when applied to a cellulosic substrate, provides a recording media that has enhanced print density for cyan, magenta and black flexographic printing inks, as well as methods of using and making the composition and media. Also, the present invention relates to a method of achieving enhanced print density with flexographic printing ink compositions at reduced concentrations of ink.

### BACKGROUND OF THE INVENTION

The performance variables of paper substrates vary greatly themselves depending upon the vast array of end-uses for such substrates. Paper substrates having the so-called, “I-Beam” structure have been recently developed and are reported to have improved bulk stiffness and/or high dimensional stability. See, for example, U.S. Patent Application Publication 2004/0065423, published on Apr. 8, 2004, which discloses a three-layered single-ply I-Beam structure sheet with a cellulosic central layer and top and bottom layers having starch-based size pressed coatings. See also U.S. Patent Application Publication 2008/0035292, published on Feb. 14, 2008, which discloses paper substrates having high dimensional stability with high surface sizing and low internal sizing.

Calcium chloride is currently used in ink jet recording media to enhance inkjet print density and dry time. See, for example, U.S. Patent Application Publication 2007/0087138, published on Apr. 19, 2007, which discloses a recording sheet with improved image dry time which contains water soluble divalent metal salts. Other metal salts have been used in ink jet recording media. U.S. Pat. No. 4,381,185 discloses paper stock which contains polyvalent metal cations. U.S. Pat. No. 4,554,181 discloses an ink jet recording sheet having a recording surface which includes a water soluble polyvalent metal salt. U.S. Pat. No. 6,162,328 discloses a paper sizing for ink jet printing substrate that includes various cationic metal salts. U.S. Pat. No. 6,207,258 discloses a surface treatment composition for an ink jet printing substrate which contains a divalent metal salt. U.S. Pat. No. 6,880,928 discloses an ink jet recording base paper having a coating which includes a polyvalent metal salt.

There is thus a need for a recording sheet in which improved ink jet print density and other benefits are maintained but which avoids the runnability and formulation issues associated with calcium chloride.

### SUMMARY OF THE INVENTION

The above problems, and others, are solved by the present invention. The present invention is related to the flexographic printing on a calcium chloride-containing paper substrate having 1) the ability to dilute flexo inks and achieve enhanced or equal print densities and 2) the ability to enhance print densities of conventional undiluted flexo inks. Quite surprisingly, the present inventors have found that a recording sheet, comprising at least one water soluble divalent metal salt and an I-beam structure exhibits a significantly improved gamut volume, ink jet print density, and several other advantages mentioned herein. These advantages could not have been predicted. Without wishing to be bound by theory, it is believed that the effective surface concentration of water soluble divalent metal salts is enhanced with the I-beam structure; and the enhanced effective surface concentration in combination with the I-beam structure allows a reduction in the overall amount of additives in the recording sheet without sacrificing performance. Still other advantages include reduced ink transfer immediately after printing, improved image black density, and improved edge acuity when printed with pigment-based inks.

Accordingly, the present invention is directed to a method of making a printed substrate paper comprising forming an image onto at least one surface of a treated substrate paper using a flexoprinting process. The treated substrate paper comprises a composition comprising lingo cellulosic fibers and a water soluble divalent metal salt. The image is formed with a flexoprinting ink and the flexoprinting ink is a pigmented ink. The pigmented ink has a particle size that ranges from about 1 nm to about 15000 micron. The pigmented ink is diluted prior to forming the image. The dilution is at least 1% to about 20% based upon the standard concentration of conventional flexoprinting pigmented ink. The treated substrate paper exhibits from about 4% to about 5.5% higher optical print density than a non-treated substrate paper. The treated substrate paper printed with a 4.0 volume anilox exhibits at least 5% reduction in optical density vs. a non-treated substrate paper and the treated substrate paper exhibits substantially higher hygroexpansivity in the CD direction when compared to the non-treated substrate paper.

The present invention is also directed to a method of making a printed substrate paper comprising forming an image onto at least one surface of the printed substrate paper using a flexoprinting process. The substrate paper comprising a sizing composition having lingo cellulosic fibers and a water soluble divalent metal salt to form a treated substrate paper wherein the sizing composition contain from 1 to 3 wt % of the divalent metal salt based on the total weight of the solids in the composition.

The present invention is further directed to a method of improving the print quality of a flexo-printed paper substrate comprising flexoprinting an image to a treated paper substrate. The treated substrate comprises a composition comprising lingo cellulosic fibers and a water soluable divalent metal salt to form the image having an improved print quality. The improved print quality is at least 5% to about 10% greater than a print quality of a printed substrate without the composition as measured with black, cyan, or magenta flexoprinting inks according to TAPPI method T-1213 sp 03. The optical density for each of the black, cyan, or magenta flexoprinting inks is from at least 0.5 to 1.5.

One further embodiment of the present invention desirably attains equal or better print density and dry time at much lower metal salt levels. One embodiment of the present invention achieves lower amounts of metal salt, such as calcium chloride; improved paper machine runnability; and desirably reduced interaction with other papermaking chemicals. Other advantages of the present invention are reduced amounts of additives at the paper machine, which improves the runnability of the paper machine and reduces cost without sacrificing performance.

Yet in another embodiment, the present inventors have found that the addition of surface pigments such as GCC (ground calcium carbonate), PCC (precipitated calcium carbonate), and others synergistically improves the gamut volume and dry time.

### BRIEF DESCRIPTION OF THE DRAWINGS

Various embodiments of the present invention are described in conjunction with the accompanying drawings, in which:

FIG. 1 illustrates a paper substrate that has a web of cellulose fibers and a sizing composition where the sizing composition has minimal interpenetration of the web of cellulose fibers.

FIG. 2 illustrates a paper substrate that has a web of cellulose fibers and a sizing composition where the sizing composition interpenetrates the web of cellulose fibers.

FIG. 3 illustrates a paper substrate that has a web of cellulose fibers and a sizing solution where the sizing composition is approximately evenly distributed throughout the web of cellulose fibers.

FIGS. 4-7 are graphs depicting higher average optical densities for Calcium Chloride treated paper than non-Calcium Chloride paper for exemplary embodiments in the examples.

FIGS. 8-13 are six flexographic Fluid inks press trail for exemplary embodiments in the examples.

FIGS. 14-19 are six flexographic Inx inks press trail for exemplary embodiments in the examples.

### DETAIL DESCRIPTION OF THE INVENTION

This invention is directed to a composition that, when applied to a cellulosic substrate, provides a recording media that has enhanced print density for cyan, magenta and black flexographic printing inks, as well as methods of using and making the composition and media. Also, the present invention relates to a method of achieving enhanced print density with flexographic printing ink compositions at reduced concentrations.

This invention also relates to a recording sheet for use in printing comprising a substrate formed from lingo cellulosic fibers and having in contact with at least one surface thereof a water soluble divalent metal salt. The inventors have surprisingly discovered that sizing level of the substrate, as measured by the HST of the substrate, and the amount of divalent metal salts on the surface of the substrate impact on image dry time of the recording sheet. The recording sheet of this invention exhibits enhanced image dry time as determined by the amount of ink transferred from a printed to an unprinted portion of the recording sheet after rolling with a roller of fixed weight. The “ink transfer”, that is defined as the amount of optical density transferred after rolling with a roller; it is expressed as a percentage of the optical density transferred to the unprinted portion of the recording sheet after rolling with a roller. The method involves printing solid colored blocks on paper, waiting for a fixed amount of time, 5 seconds after printing, and then folding in half so that the printed portion contacts an unprinted portion of the recording sheet, and rolling with a 4.5 lb hand roller as for example roller item number HR-100 from Chem Instruments, Inc., Mentor, Ohio, USA. The optical density is read on the transferred (OD_{T}), the non-transferred (OD_{O}) portions of the block, and an un-imaged area (OD_{B}) by a reflectance densitometer (X-Rite, Macbeth. etc.). The percent transferred (“IT %”) is defined as IT %=[(OD_{T}−OD_{B})/(OD_{O}−OD_{B})]×100.

The Hercules Sizing Test Value (“HST”) of the substrate and the amount of divalent salt are selected such that the recording sheet has a percent ink transferred (“IT %”) equal to or less than about 60. Preferably, the IT % is from 0% to about 50%. More preferably, the IT % is from 0% to about 40%. Most preferably, the IT % is from 0% to about 30%.

In addition to improved image dry time, some recording sheets of this invention preferably exhibit good print quality. As used herein, print quality (PQ) is measured by two important parameters: print density and edge acuity. Print density is measured using a reflectance densitometer (X-Rite, Macbeth. etc.) in units of optical density (“OD”). The method involves printing a solid block of colour on the sheet, and measuring the optical density. There is some variation in OD depending on the particular printer used and the print mode chosen, as well as the densitometer mode and colour setting. The printer used in this patent is an HP Deskjet 6122, manufactured by Hewlett-Packard, which uses a #45 (HP product number 51645A) black ink jet cartridge. The print mode is determined by the type of paper and the print quality selected. For the data in this patent, the default setting of Plain Paper type and Fast Normal print quality print mode was selected. The densitometer used was an X-Rite model 528 spectrodensitometer with a 6 mm aperture. The density measurement settings were Visual color, status T, and absolute density mode. An increase in print density is usually seen when sufficient amounts of divalent water soluble metal salts are on the paper surface. In general, the target optical density for pigment black (“OD_{O}”) is equal to or greater than 1.30 in the standard (plain paper, normal) print mode for the HP desktop ink jet printers that use the most common black pigment ink (equivalent to the #45 ink jet cartridge). Preferably, the OD_{O} is equal to or greater than about 1.40. More preferably, the OD_{O} is equal to or greater than about 1.50. Most preferably, the OD is equal to or greater than about 1.60.

Another parameter of recording sheets that is important to the determination of good print quality is the edge acuity (“EA”). Some recording sheets of this invention exhibit good edge acuity. Edge acuity is measured by an instrument such as the QEA Personal Image Analysis System (Quality Engineering Associates, Burlington, Mass.), the QEA ScannerIAS, or the ImageXpert KDY camera-based system. All of these instruments collect a magnified digital image of the sample and calculate an edge acuity value by image analysis. This value is also called edge raggedness, and is defined in ISO method 13660. The method involves printing a solid line 1.27 millimeters or more in length, sampling at a resolution of at least 600 dpi. The instrument calculates the location of the edge based on the darkness of each pixel near the line edges. The edge threshold is defined as the point of 60% transition from the substrate reflectance factor (light area, Rₘₐₓ) to the image reflectance factor (dark area, Rₘₐₓ) using the equation R₆₀=Rₘₐₓ−60% (Rₘₐₓ−Rₘᵢₙ). The edge raggedness is then defined as the standard deviation of the residuals from a line fitted to the edge threshold of the line, calculated perpendicular to the fitted line. The value of edge acuity is preferably less than about 15. Preferably, the EA is less than about 12. More preferably, the EA is less than about 10. Most preferably, the EA is less than about 8.

One essential component of the recording sheet of this invention is a substrate comprised of lingo cellulosic fibers. The type of fiber is not critical and any such fiber known for use in paper making can be used. For example, the substrate can made from pulp fibers derived from hardwood trees, softwood trees, or a combination of hardwood and softwood trees prepared for use in a papermaking furnish by any known suitable digestion, refining, and bleaching operations as for example known mechanical, thermomechanical, chemical and semichemical, etc., pulping and other well known pulping processes. The term “hardwood pulps” as used herein refers to fibrous pulp derived from the woody substance of deciduous trees (angiosperms) such as birch, oak, beech, maple, and eucalyptus, whereas “softwood pulps” are fibrous pulps derived from the woody substance of coniferous trees (gymnosperms) such as varieties of fir, spruce, and pine, as for example loblolly pine, slash pine, Colorado spruce, balsam fir and Douglas fir. In certain embodiments, at least a portion of the pulp fibers may be provided from non-woody herbaceous plants including, but not limited to, kenaf, hemp, jute, flax, sisal, or abaca although legal restrictions and other considerations may make the utilization of hemp and other fiber sources impractical or impossible. Either bleached or unbleached pulp fiber may be utilized in the process of this invention. Recycled pulp fibers are also suitable for use. In a preferred embodiment, the cellulosic fibers in the paper include from about 30% to about 100% by weight dry basis softwood fibers and from about 70% to about 0% by weight dry basis hardwood fibers.

In addition to the lingo cellulosic fibers, the substrate may also include other conventional additives such as, for example, fillers, retention aids, wet strength resins and dry strength resins that may be incorporated into lingo cellulosic fiber based substrates. Among the fillers that may be used are inorganic and organic pigments such as, by way of example, minerals such as calcium carbonate, barium sulfate, titanium dioxide, calcium silicates, mica, kaolin and talc, and polymeric particles such as polystyrene latexes and polymethylmethacrylate. Other conventional additives include, but are not restricted to, alum, fillers, pigments and dyes.

The paper substrate may also include dispersed within the lingo cellulose fibers from expanded or unexpanded microspheres. Expanded and expandable microspheres are well known in the art. For example, suitable expandable microspheres are described in co-pending applications Ser. No. 09/770,340 filed Jan. 26, 2001 and Ser. No. 10/121,301, filed Apr. 11, 2002; U.S. Pat. Nos. 3,556,934, 5,514,429, 5,125,996, 3,533,908, 3,293,114, 4,483,889, and 4,133,688; and UK Patent Application 2307487, the contents of which are incorporated by reference. All conventional microspheres can be used in the practice of this invention. Suitable microspheres include synthetic resinous particles having a generally spherical liquid-containing center. The resinous particles may be made from methyl methacrylate, ortho-chlorostyrene, polyortho-chlorostyrene, polyvinylbenzyl chloride, acrylonitrile, vinylidene chloride, para-tert-butyl styrene, vinyl acetate, butyl acrylate, styrene, methacrylic acid, vinylbenzyl chloride and combinations of two or more of the foregoing. Preferred resinous particles comprise a polymer containing from about 65 to about 90 percent by weight vinylidene chloride, preferably from about 65 to about 75 percent by weight vinylidene chloride, and from about 35 to about 10 percent by weight acrylonitrile, preferably from about 25 to about 35 percent by weight acrylonitrile. Suitable expandable microspheres are available from Akzo Nobel of Marietta, Ga. under the trade name EXPANCEL. Expandable microspheres and their usage in paper materials are described in more detail in co-pending application Ser. No. 09/770,340 filed Jan. 26, 2001 and co-pending application Ser. No. 10/121,301, filed Apr. 11, 2002, the contents of which are incorporated by reference.

The Hercules Sizing Test Value (“HST”) of the substrate may vary widely and is selected to provide the desired dry time characteristics. The HST value is measured following the conventions described in TAPPI Standard Method number T-530, using 1% formic acid ink and 80% reflectance endpoint. This test is commonly used for alkaline papers containing calcium carbonate filler, as noted in the TAPPI Journal article by S. R. Boone, February, 1996, pg 122. The HST of the substrate can be adjusted by the addition of a sizing agent to the substrate. It is preferred that the desired HST is obtained by internally sizing the substrate; that is, that sizing agents be added to the pulp suspension before it is converted to a paper web or substrate. Internal sizing helps prevent the surface size from soaking into the sheet, thus allowing it to remain on the surface where it has maximum effectiveness. The internal sizing agents for use in the practice of this invention encompass any of those commonly used at the wet end of a paper machine. These include rosin sizes, ketene dimers and multimers, and alkenylsuccinic anhydrides. The internal sizes are generally used at concentration levels known to art as for examples at levels of from about 0 wt. % to about 1.0 wt. % based on the weight of the dry paper sheet. More preferably, the internal size is used at levels of about 0.01% to about 0.5 wt. %. Most preferably, the internal size is used at levels of about 0.025% to about 0.25 wt. %. Methods and materials utilized for internal sizing with rosin are discussed by E. Strazdins in The Sizing of Paper, Second Edition, edited by W. F. Reynolds, TAPPI Press, 1989, pages 1-33. Suitable ketene dimers for internal sizing are disclosed in U.S. Pat. No. 4,279,794, which is incorporated by reference in its entirety, and in United Kingdom Patent Nos. 786,543; 903,416; 1,373,788 and 1,533,434, and in European Patent Application Publication No. 0666368 A3. Ketene dimers are commercially available, as Aquapel® and Precis® sizing agents from Hercules Incorporated, Wilmington, Del. Ketene multimers for use in internal sizes are described in European Patent Application Publication No. 0629741A1, corresponding to U.S. patent application Ser. No. 08/254,813, filed Jun. 6, 1994; European Patent Application Publication No. 0666368A3, corresponding to U.S. patent application Ser. No. 08/192,570, filed Feb. 7, 1994; and U.S. patent application Ser. No. 08/601,113, filed Feb. 16, 1996. Alkenyl succinic anhydrides for internal sizing are disclosed in U.S. Pat. No. 4,040,900, which in incorporated herein by reference in its entirety, and by C. E. Farley and R. B. Wasser in The Sizing of Paper, Second Edition, edited by W. F. Reynolds, TAPPI Press, 1989, pages 51-62. A variety of alkenylsuccinic anhydrides are commercially available from Albemarle Corporation, Baton Rouge, La.

As it is well known to those of ordinary skill in the art, the HST will vary directly with the basic weight of the substrate and other factors known to those of ordinary skill in the art as for example the amount and type of internal sizing agent as well as the type, amount, and surface area of filler, the ink used and the reflectance end point as specified in TAPPI T 530 Based upon the foregoing information, one of ordinary skill in the art can use conventional techniques and procedures to calculate, determine and/or estimate a particular HST for the substrate used to provide the desired image dry time characteristics. In the preferred embodiments of this invention, the HST value is preferably from about 1 second to about 400 seconds with 1% formic acid ink and 80% reflectance. The HST is more preferably from about 3 seconds to about 300 seconds and most preferably from about 5 seconds to about 200 seconds. In the embodiments of choice, the HST is from about 20 seconds to about 100 seconds.

The Gurley porosity of the base substrate is selected to provide the desired dry time characteristics. The Gurley porosity is measured by the procedure of TAPPI T460 om-88. In the preferred embodiments of this invention, the substrate has a Gurley porosity preferably from about 5 sec/100 ml to about 75 sec/100 ml. The Gurley porosity is more preferably from about 5 sec/100 ml to about 70 sec/100 ml and most preferably from about 5 sec/100 ml to about 50 sec/100 ml. In the embodiments of choice, the Gurley porosity is from about 10 sec/100 ml to about 35 sec/100 ml.

The pore diameter of the substrate is selected to provide the desired dry time characteristics. The pore diameter is measured by mercury intrusion porosimetry. In the preferred embodiments of this invention, the substrate has a pore diameter is preferably from about 2.0 to about 3.5. The pore diameter is more preferably from about 2.2 to about 3.3 and most preferably from about 2.4 to about 3.1. In the embodiments of choice, the pore diameter is from about 2.6 to about 3.0.

The substrate can be of any basis weight. Preferably, the substrate basis weight is from about 20 to about 500 g/m², although substrate basis weight can be outside of this range if desired. The basis weight is more preferably from about 20 to about 300 g/m² and most preferably from about 50 to about 200 g/m². In the embodiments of choice, the basis weight is from about 60 to about 120 g/m².

Suitable substrates can be purchased from commercial sources as for example International Paper Company of prepared by conventional techniques. Methods and apparatuses for preparing a substrate formed of lingo cellulosic fibers are well known in the paper and paperboard art. See for example “Handbook For Pulp & Paper Technologies”, 2^{nd} Edition, G. A. Smook, Angus Wilde Publications (1992) and references cited therein. Any conventional method and apparatus can be used. Preferably the process comprises: a) providing an aqueous suspension of lingo cellulosic fibers; b) sheeting and drying the aqueous lingo cellulosic fiber suspension to obtain dried paper web; c) drying the paper web to obtain dried paper web and d) calendering the dried paper web. In addition to these process steps, additional process steps known to those of ordinary skill in the art may be employed as for example a coating step to coat one or more surfaces of the web with a coating comprising a binder containing dispersant pigment.

The substrate contains an “effective amount” of the divalent water soluble metal salt preferably in contact with at least one surface of the substrate. As used herein, an “effective amount” is an amount which is sufficient to enhance the dry time of the substrate to any extent. This total amount of divalent water soluble metal salt in the substrate can vary widely, provided that the desired result is achieved. Usually, this amount is at least 0.02 g/m², although lower or higher amounts can be used. The amount of divalent water soluble metal salt is preferably from about 0.1 g/m² to about 3 g/m⁻¹ and most preferably from about 0.2 g/m² to about 2.0 g/m². In the embodiments of choice, The amount of divalent water soluble metal salt is preferably from about 0.4 g/m² to about 1.5 g/m².

Any divalent metal salt can be used in the practice of this invention. Suitable divalent water soluble metal salts include but are not limited to compounds containing calcium or magnesium. The counter ions may vary widely and include chloride, sulfate, nitrate, hydroxide and the like. Illustrative of such materials are calcium chloride, magnesium chloride, and calcium hydroxide. Preferred divalent water soluble metal salts for use in the practice of this invention are water soluble calcium salts, especially calcium chloride.

When the preferred divalent water soluble metal salt, calcium chloride, and the preferred Ethylex 2035 starch are used, the desired dry time of the sheet is obtained when the weight ratio of the calcium chloride to the starch is equal to or greater than about 5% to about 200%. In these embodiments, the weight ratio of the calcium chloride to the starch is preferably from about 5% to about 100%, more preferably from about 7% to about 70%, and most preferably from about 10% to about 40%.

In these preferred embodiments of the invention, the amount of the mixture of divalent water soluble metal salt and one or more starches on the surface of a substrate may vary widely and any conventional amount can be used. In general, the amount of the mixture in the substrate is at least about 0.02 g/m² of recording sheet, although higher and lower amounts can be used. The amount is preferably at least about 0.05 g/m², more preferably at least about 1.0 g/m² and most preferably from about 1.0 g/m² to about 4.0 g/m².

In addition to the required divalent metal salt, the mixture used to treat the substrate may include other ingredients in addition to the starch used in the preferred embodiments of the invention, including a pigment typically applied to the surface of a recording sheet in conventional amounts. Such optional components also include dispersants, surface sizing agents, optical brighteners, fluorescent dyes, surfactants, deforming agents, preservatives, pigments, binders, pH control agents, coating releasing agents, and the like.

Other optional components are nitrogen containing compounds. Suitable nitrogen containing organic species are compounds, oligomers and polymers are those containing one or more quaternary ammonium functional groups. Such functional groups may vary widely and include substituted and unsubstituted amines, imines, amides, urethanes, quaternary ammonium groups, dicyandiamides, guanides, and the like. Illustrative of such materials are polyamines, polyethyleneimines, copolymers of diallyldimethyl ammonium chloride (DADMAC), copolymers of vinyl pyrrolidone (VP) with quaternized diethylaminoethylmethacrylate (DEAMEMA), polyamides, cationic polyurethane latex, cationic polyvinyl alcohol, polyalkylamines dicyandiamid copolymers, amine glycigyl addition polymers, poly[oxyethylene (dimethyliminio) ethylene (dimethyliminio) ethylene] dichlorides, guanidine polymers, and polymeric biguanides. These types of compounds are well known, and are described in, for example, U.S. Pat. No. 4,554,181, U.S. Pat. No. 6,485,139, U.S. Pat. No. 6,686,054, U.S. Pat. No. 6,761,977, and U.S. Pat. No. 6,764,726.

Preferred nitrogen containing organic species for use in the practice of this invention are low to medium molecular weight cationic polymers and oligomers having a molecular equal to or less than 100,000, preferably equal to or less than about 50,000 and more preferably from about 10,000 to about 50,000. Illustrative of such materials are polyalkylamine dicyandiamide copolymers, poly [oxyethylene (dimethyliminio ethylene (dimethyliminioethylene] dichlorides and polyamines having molecular weights within the desired range. More preferred nitrogen containing organic species for use in the practice of this invention are low molecular weight cationic polymers such as polyalkylamine dicyandiamid copolymer, poly [oxyethylene (dimethyliminio) ethylene (dimethyliminio) ethylene] dichloride, guanidine polymers, and polymeric biguanides. Most preferred nitrogen containing organic species for use in the practice of this invention is low molecular weight polyalkylamine dicyandiamid copolymers, guanidine polymers, and polymeric biguanides such as polyhexamethylenebiguanide.

The recording sheet of this invention can be prepared using known conventional techniques. For example, the essential one or more divalent water soluble metal salt preferably admixed with one or more starches, and one or more optional components can be dissolved or dispersed in an appropriate liquid medium, preferably water, and can be applied to the substrate by any suitable technique, such as a size press treatment, dip coating, reverse roll coating, extrusion coating or the like. Such coating techniques are well known in the art and will not be described in any great detail.

The paper substrate of the present invention may have any CIE whiteness, but preferably has a CIE whiteness of greater than 70, more preferably greater than 100, most preferably greater than 125 or even greater than 150. The CIE whiteness may be in the range of from 125 to 200, preferably from 130 to 200, most preferably from 150 to 200. The CIE whiteness range may be greater than or equal to 70, 80, 90, 100, 110, 120, 125, 130, 135, 140, 145, 150, 155, 160, 65, 170, 175, 180, 185, 190, 195, and 200 CIE whiteness points, including any and all ranges and subranges therein. Examples of measuring CIE whiteness and obtaining such whiteness in a papermaking fiber and paper made therefrom can be found, for example, in U.S. Pat. No. 6,893,473, which is hereby incorporated, in its entirety, herein by reference. Further, examples of measuring CIE whiteness and obtaining such whiteness in a papermaking fiber and paper made therefrom can be found, for example, in U.S. Patent Application No. 60/654,712 filed Feb. 19, 2005, entitled “Fixation of Optical Brightening Agents Onto Papermaking Fibers”, and U.S. patent application Ser. No. 11/358,543 filed Feb. 21, 2006; Ser. No. 11/445,809 filed Jun. 2, 2006; and Ser. No. 11/446,421 filed Jun. 2, 2006, which are also hereby incorporated, in their entirety, herein by reference.

The paper substrate of the present invention may have any ISO brightness, but preferably greater than 80, more preferably greater than 90, most preferably greater than 95 ISO brightness points. The ISO brightness may be preferably from 80 to 100, more preferably from 90 to 100, most preferably from 95 to 100 ISO brightness points. This range include greater than or equal to 80, 85, 90, 91, 92, 93, 94, 95, 96, 97, 98, 99, and 100 ISO brightness points, including any and all ranges and subranges therein. Examples of measuring ISO brightness and obtaining such brightness in a papermaking fiber and paper made therefrom can be found, for example, in U.S. Pat. No. 6,893,473, which is hereby incorporated, in its entirety, herein by reference. Further, examples of measuring ISO brightness and obtaining such brightness in a papermaking fiber and paper made therefrom can be found, for example, in U.S. Patent Application No. 60/654,712 filed Feb. 19, 2005, entitled “Fixation of Optical Brightening Agents Onto Papermaking Fibers”, and U.S. patent application Ser. No. 11/358,543 filed Feb. 21, 2006, which are also hereby incorporated, in their entirety, herein by reference.

The paper substrate of the present invention preferably has an improved print performance and improved runnability (e.g. print press performance). Print performance may be measured by determining improved ink density, dot gain, trapping, print contrast, and/or print hue, to name a few. Colors traditionally used in such performance tests include black, cyan, magenta and yellow, but are by no means limited thereto. Press performance may be determined by print contamination determinations through visual inspection of press systems, blankets, plates, ink system, etc. Contamination usually consists of fiber contamination, coating or sizing contamination, filler or binder contamination, piling, etc. The paper substrate of the present invention has an improved print performance and/or runnability as determined by each or any one or combination of the above attributes.

The paper substrate may have any surface strength. Examples of physical tests of a substrate's surface strength that also seem to correlate well with a substrate's print performance are the IGT pick tests and wax pick tests. Further, both tests are known in the art to correlate well with strong surface strength of paper substrates. While either of these tests may be utilized, IGT pick tests are preferred. IGT pick test is a standard test in which performance is measured by Tappi Test Method 575, which corresponds to the standard test ISO 3873.

The paper substrate may have at least one surface having a surface strength as measured by IGT pick test that is at least about 1, preferably at least about 1.2, more preferably at least about 1.4, most preferable at least about 1.8 n/s. The substrate has a surface strength as measured by IGT pick test that is at least about 2.5, 2.4, 2.3, 2.2, 2.1, 2.0, 1.9, 1.8, 1.7, 1.6, 1.5, 1.4, 1.3, 1.2, 1.1, and 1.0 m/s, including any and all ranges and subranges therein.

Another known related test is one that which measures IGT VPP delamination and is commonly known in the art (measured in N/m). The IGT VPP delamination of the paper substrate of the present invention may be any, but is preferably greater than 150 N/m, more preferably greater than 190 N/m, most preferably greater than 210 N/m. If the substrate is a repro-paper substrate, then the IGT VPP delamination is preferably from 150 to 175 N/m, including any and all ranges and subranges therein.

The paper substrate according to the present invention may be made off of the paper machine having either a high or low basis weight, including basis weights of at least 10 lbs/3000 square foot, preferably from at least 20 to 500 lbs/3000 square foot, more preferably from at least 40 to 325 lbs/3000 square foot. The basis weight may be at least 10, 20, 30, 40, 50, 60, 70, 80, 90, 100, 125, 150, 175, 200, 225, 250, 275, 300, 325, 350, 375, 400, 425, 450, 475, and 500 lbs/3000 square feet, including any and all ranges and subranges therein.

The paper substrate according to the present invention may have any apparent density. The apparent density may be of from 1 to 20, preferably 4 to 14, most preferably from 5 to 10 lb/3000 sq. ft.per 0.001 inch thickness. The density may be at least 1, 2, 3, 4, 5, 6, 7, 8, 9, 10, 11, 12, 13, 14, 15, 16, 17, 18, 19, and 20 lb/3000 sq. ft.per 0.001 inch thickness, including any and all ranges and subranges therein.

The paper substrate according to the present invention may have any caliper. The caliper may be from 2 to 35 ml, preferably from 5 to 30 mil, more preferably from 10 to 28 mil, most preferably from 12 to 24 mil. The caliper may be at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, and 35 ml, including any and all ranges and subranges therein.

The paper substrate may optionally have an I-beam structure or perform as if an I-beam structure is contained therein. However an I-beam structure is preferred. This I-beam structure is produced as a result of the selective placement and heavily controlled locality of the sizing agent within and/or on the paper substrate. “I-Beam” and performance characteristics may be described in references such as its effect described in published application having U.S. Ser. No. 10/662,699 and having publication number 20040065423, which published on Apr. 8, 2004, which is also hereby incorporated, in its entirety, herein by reference. However, it is not known how to control the I-beam structure and/or I-Beam performance characteristics of a substrate made under paper machine and/or pilot machine conditions. An embodiment of the present invention may also include the attainment of improved I-beam structures and/or performance characteristics by tightly controlling the location of the sizing agent across the cross section of the substrate itself. Also within the current boundaries of the present invention is the opportunity to create improved I-beam structures and/or improved I-beam performance characteristics of the substrate while increasing the loading of sizing agent into and/or onto the substrate, especially controlling the external sizing agent loading therein and/or thereon.

The paper substrate of the present invention may also include optional substances including retention aids, binders, fillers, thickeners, and preservatives. Examples of fillers include, but are not limited to; clay, calcium carbonate, calcium sulfate hemihydrate, and calcium sulfate dehydrate. A preferable filler is calcium carbonate with the preferred form being precipitated calcium carbonate. Examples of binders include, but are not limited to, polyvinyl alcohol, Amres (a Kymene type), Bayer Parez, polychloride emulsion, modified starch such as hydroxyethyl starch, starch, polyacrylamide, modified polyacrylamide, polyol, polyol carbonyl adduct, ethanedial/polyol condensate, polyamide, epichlorohydrin, glyoxal glyoxal urea, ethanedial, aliphatic polyisocyanate, isocyanate, 1,6 hexamethylene diisocyanate, diisocyanate, polyisocyanate, polyester, polyester resin, polyacrylate, polyacrylate resin, acrylate, and methacrylate. Other optional substances include, but are not limited to silicas such as colloids and/or sols. Examples of silicas include, but are not limited to, sodium silicate and/or borosilicates. Another example of optional substances is solvents including but not limited to water.

The paper substrate of the present invention may contain retention aids selected from the group consisting of coagulation agents, flocculation agents, and entrapment agents dispersed within the bulk and porosity enhancing additives cellulosic fibers. Examples of retention aids can also be found in U.S. Pat. No. 6,379,497, which is incorporated by reference in its entirety.

The paper substrate may be made by contacting the sizing agent with the cellulose fibers. Still further, the contacting may occur at acceptable concentration levels that provide the paper substrate of the present invention to contain any of the above-mentioned amounts of cellulose and sizing agent.

The paper substrate of the present application may be made by contacting the substrate with an internal and/or surface sizing solution containing at least one sizing agent. The contacting may occur anytime in the papermaking process including, but not limited to the wet end, head box, size press, water box, and/or coater. Further addition points include machine chest, stuff box, and suction of the fan pump. The cellulose fibers, sizing agent, and/or optional components may be contacted serially, consecutively, and/or simultaneously in any combination with each other.

The paper substrate may be passed through a size press, where any sizing means commonly known in the art of papermaking is acceptable. The size press, for example, may be a puddle mode size press (e.g. inclined, vertical, horizontal) or metered size press (e.g. blade metered, rod metered). At the size press, sizing agents such as binders may be contacted with the substrate. Optionally these same sizing agents may be added at the wet end of the papermaking process as needed. After sizing, the paper substrate may or may not be dried again according to the above-mentioned exemplified means and other commonly known drying means in the art of papermaking. The paper substrate may be dried so as to contain any selected amount of water. Preferably, the substrate is dried to contain less than or equal to 10% water.

Preferably, the paper substrate is made by having at least one sizing agent contacted with the fibers at a size press. Therefore, the sizing agent is part of a sizing solution. The sizing solution preferably contains at least one sizing agent at a % solids that is at least 8 wt %, preferably at least or equal to 10 wt %, more preferably greater than or equal to 12 wt %, most preferably, greater than or equal to 13 wt % solids sizing agent. Further, the sizing solution contains from 8 to 35 wt % solids sizing agent, preferably from 10 to 25 wt % solids sizing agent, more preferably from 12 to 18 wt % solids sizing agent, most preferably from 13 to 17 wt % solids sizing agent. This range includes at least 8, 10, 12, 13, 14 wt % solids sizing agent and at most 15, 16, 17, 18, 20, 22, 25, 30, and 35 wt % solids sizing agent, including any and all ranges and subranges therein.

The sizing agent loading applied to the paper, which is about equal to, or exactly equal to the amount of external sizing and, in some instances, the total sizing, applied to the fibers may be any loading. Preferably, the sizing agent load is at least 0.25 gsm, preferably from 0.25 to 10 gsm, more preferably from 3.5 to 10 gsm, most preferably from 4.4 to 10 gsm. The sizing agent load may preferably be at least 0.25, 0.5, 1.0, 1.5, 2.0, 2.5, 3.0, 35, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, and may preferably be at most 7.0, 7.5, 8.0, 8.5, 9.0, 9.5, and 10.0 gsm, including any and all ranges and subranges therein.

The paper substrate may have any Internal Bond/sizing agent load ratio. In one aspect of the present invention, the substrate contains high amounts of sizing agent and/or sizing agent load, while at the same time has low Internal Bond. Accordingly, it is preferable to have the Internal Bond/sizing agent load ratio approach 0, if possible. Another manner in expressing the desired phenomenon in the substrate of the present invention, is to provide a paper substrate that has an Internal Bond that either decreases, or remains constant, or increases minimally with increasing sizing content and/or sizing loading. Another way to discuss this phenomenon is to say that the change in Internal Bond of the paper substrate is 0, negative, or a small positive number as the sizing agent load increases. It is desirable to have this paper substrate of the present invention presenting such a phenomenon at various degrees of sizing agent wt % solids that are applied to the fibers via a size press as discussed above. In an additional embodiment, it is desirable to have the paper substrate to possess any one of and/or all of the above-mentioned phenomena and also have a strong surface strength as measured by IGT pick and/or wax pick tests discussed above.

The paper substrate of the present invention may have any Internal Bond/sizing agent load ratio. The Internal Bond/sizing agent load ratio may be less than 100, preferably less than 80, more preferably less than 60, most preferably less than 40 J/m²/gsm. The Internal Bond/sizing agent load ratio may be less than 100, 95, 90, 85, 80, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 38, 35, 32, 30, 28, 25, 22, 20, 18, 15, 12, 10, 7, 5, 4, 3, 2, and 1 J/m²/gsm, including any and all ranges and subranges therein.

When the fibers are contacted with the sizing agent at the size press, it is preferred that the viscosity of the sizing solution is from 100 to 500 centipoise using a Brookfield Viscometer, number 2 spindle, at 100 rpm and 150° F. Preferably, the viscosity is from 125 to 450, more preferably from 150 to 300 centipoise as measured by the standard indicated above. This range includes 100, 125, 150, 160, 170, 180, 190, 200, 210, 220, 230, 240, 250, 260, 270, 280, 290, 300, 325, 350, 375, 400, 425, and 450 centipoise as measured using a Brookfield Viscometer, number 2 spindle, at 100 rpm and 150° F., including any and all ranges and subranges therein.

When the sizing solution containing the sizing agent is contacted with the fibers at the size press to make the paper substrate of the present invention, the effective nip pressure may be any nip pressure, but preferable is from 80 to 300, more preferably from 90 to 275, most preferably from 100 to 250 lbs per linear inch. The nip pressure may be at least 80, 90, 100, 110, 120, 130, 140, 150, 160, 170, 180, 190, 200, 210, 220, 230, 240, 250, 260, 270, 280, 290, and 300 lbs per linear inch, including any and all ranges and subranges therein.

In addition, the rolls of the size press may have a P&J hardness, preferably any P&J hardness. Since there are two rolls, a first roll may have a first hardness, while a second roll may have a second hardness. The first hardness and the second hardness may be equal and/or different from one another. As an example, the P&J of a first roll at the size press may have a first hardness that is 35 P&J hardness, while the second roll has a second hardness that is 35 P&J hardness. Alternatively and only to exemplify, the P&J of a first roll at the size press may have a first hardness that is 35 P&J hardness, while the second roll have a second hardness that is 45 P&J hardness. Even though the rolls may have any P&J, it is preferred that the rolls be softer rather than harder at the size press.

The paper board and/or substrate of the present invention may also contain at least one coating layer, including two coating layers and a plurality thereof. The coating layer may be applied to at least one surface of the paper board and/or substrate, including two surfaces. Further, the coating layer may penetrate the paper board and/or substrate. The coating layer may contain a binder. Further the coating layer may also optionally contain a pigment. Other optional ingredients of the coating layer are surfactants, dispersion aids, and other conventional additives for printing compositions.

The substrate and coating layer are contacted with each other by any conventional coating layer application means, including impregnation means. A preferred method of applying the coating layer is with an in-line coating process with one or more stations. The coating stations may be any of known coating means commonly known in the art of papermaking including, for example, brush, rod, air knife, spray, curtain, blade, transfer roll, reverse roll, and/or cast coating means, as well as any combination of the same.

The coated substrate may be dried in a drying section. Any drying means commonly known in the art of papermaking and/or coatings may be utilized. The drying section may include and contain IR, air impingement dryers and/or steam heated drying cans, or other drying means and mechanisms known in the coating art.

The coated substrate may be finished according to any finishing means commonly known in the art of papermaking. Examples of such finishing means, including one or more finishing stations, include gloss calendar, soft nip calendar, and/or extended nip calendar.

These above-mentioned methods of making the composition, particle, and/or paper substrate of the present invention may be added to any conventional papermaking processes, as well as converting processes, including abrading, sanding, slitting, scoring, perforating, sparking, calendaring, sheet finishing, converting, coating, laminating, printing, etc. Preferred conventional processes include those tailored to produce paper substrates capable to be utilized as coated and/or uncoated paper products, board, and/or substrates. Textbooks such as those described in the “Handbook for pulp and paper technologists” by G. A. Smook (1992), Angus Wilde Publications, which is hereby incorporated, in its entirety, by reference. For example, the fiber may be prepared for use in a papermaking furnish by any known suitable digestion, refining, and bleaching operations as for example known mechanical, thermo mechanical, chemical and semi chemical, etc., pulping and other well known pulping processes. In certain embodiments, at least a portion of the pulp fibers may be provided from non-woody herbaceous plants including, but not limited to, kenaf, hemp, jute, flax, sisal, or abaca although legal restrictions and other considerations may make the utilization of hemp and other fiber sources impractical or impossible. Either bleached or unbleached pulp fiber may be utilized in the process of this invention.

The substrate may also include other conventional additives such as, for example, starch, mineral and polymeric fillers, retention aids, and strengthening polymers. Among the fillers that may be used are organic and inorganic pigments such as, by way of example, minerals such as calcium carbonate, kaolin, and talc and expanded and expandable microspheres. Other conventional additives include, but are not restricted to, wet strength resins, internal sizes, dry strength resins, alum, fillers, pigments and dyes. The substrate may include bulking agents such as expandable microspheres, pulp fibers, and/or diamide salts.

Examples of expandable microspherese having bulking capacity are those described in U.S. Patent Application No. 60/660,703 filed Mar. 11, 2005, entitled “COMPOSITIONS CONTAINING EXPANDABLE MICROSPHERES AND AN IONIC COMPOUND, AS WELL AS METHODS OF MAKING AND USING THE SAME”, and U.S. patent application Ser. No. 11/374,239 filed Mar. 13, 2006, which are also hereby incorporated, in their entirety, herein by reference. Further examples include those found in U.S. Pat. No. 6,379,497 filed May 19, 1999 and United States patent application having Publication Number 20060102307 filed Jun. 1, 2004, which are also hereby incorporated, in their entirety, herein by reference. When such bulking agents are added, from 0.25 to 20, preferably from 3 to 15 lb of bulking agent are added (e.g. expandable microspheres and/or the composition and/or particle discussed below) per ton of cellulose fibers.

Examples of bulking fibers include, for example, mechanical fibers such as ground wood pulp, BCTMP, and other mechanical and/or semi-mechanical pulps. A more specific representative example is provided below. When such pulps are added, from 0.25 to 75 wt %, preferably less than 60 wt % of total weight of the fibers used may be from such bulking fibers.

Examples of diamide salts include those described in United States patent application having Publication Number 20040065423 filed Sep. 15, 2003, which is also hereby incorporated, in their entirety, herein by reference. Such salts include mono- and distearamides of animoethylethalonalamine, which may be commercially known as Reactopaque 100, (Omnova Solutions Inc., Performance Chemicals, 1476 J. A. Cochran By-Pass, Chester, S.C. 29706, USA and marketed and sold by Ondeo Nalco Co., with headquarters at Ondeo Nalco Center, Naperville, Ill. 60563, USA) or chemical equivalents thereof. When such salts are used, about 0.025 to about 0.25 wt % by weight dry basis of the diamide salt may be used.

In one embodiment of the present invention, the substrate may include bulking agents such as those described in U.S. Patent Application No. 60/660,703 filed Mar. 11, 2005, entitled “COMPOSITIONS CONTAINING EXPANDABLE MICROSPHERES AND AN IONIC COMPOUND, AS WELL AS METHODS OF MAKING AND USING THE SAME”, which is also hereby incorporated, in its entirety, herein by reference. This embodiment is explained in detail below.

The paper substrate of the present invention may contain from 0.001 to 10 wt %, preferably from 0.02 to 5 wt %, more preferably from 0.025 to 2 wt %, most preferably from 0.125 to 0.5 wt % of the composition and/or particle of the present invention based on the total weight of the substrate. The range includes 0.001, 0.005, 0.01, 0.05, 1.0, 1.5, 2.0, 2.5, 3.0, 3.5, 4.0, 4.5, and 5.0 wt %, including any and all ranges and subranges therein.

The paper substrate according to the present invention may contain a bulking means/agent ranging from 0.25 to 50, preferably from 5 to 20, dry lb per ton of finished product when such bulking means is an additive. This range includes 0.25, 0.5, 0.75, 1.0, 2.0, 2.5, 3.0, 3.5, 4, 4.5, 5, 5.5, 6, 6.5, 7, 7.5, 8, 8.5, 9, 9.5, 10, 11, 12, 13, 14, 15, 20, 25, 30, 35, 40, 45, and 50 dry lb per ton of finished product, including any and all ranges and subranges therein.

When the paper substrate contains a bulking agent, the bulking agent is preferably an expandable microsphere, composition, and/or particle for bulking paper articles and substrates. However, in this specific embodiment, any bulking means can be utilized, while the expandable microsphere, composition, particle and/or paper substrate of that follows is the preferred bulking means. Examples of other alternative bulking means may be, but is not limited to, surfactants, Reactopaque, pre-expanded spheres, BCTMP (bleached chemi-thermomechanical pulp), microfinishing, and multiply construction for creating an I-Beam effect in a paper or paper board substrate. Such bulking means may, when incorporated or applied to a paper substrate, provide adequate print quality, caliper, basis weight, etc in the absence harsh calendaring conditions (i.e. pressure at a single nip and/or less nips per calendaring means), yet produce a paper substrate having the a single, a portion of, or combination of the physical specifications and performance characteristics mentioned herein.

When the paper substrate of the present invention contains a bulking agent, the preferred bulking agent is as follows:

The paper substrate of the present invention may contain from 0.001 to 10 wt %, preferably from 0.02 to 5 wt %, more preferably from 0.025 to 2 wt %, most preferably from 0.125 to 0.5 wt % of expandable microspheres based on the total weight of the substrate.

The expandable microspheres may contain an expandable shell forming a void inside thereof. The expandable shell may comprise a carbon and/or heteroatom containing compound. An example of a carbon and/or heteroatom containing compound may be an organic polymer and/or copolymer. The polymer and/or copolymer may be branched and/or crosslinked.

Expandable microspheres preferably are heat expandable thermoplastic polymeric hollow spheres containing a thermally activatable expanding agent. Examples of expandable microsphere compositions, their contents, methods of manufacture, and uses can be found, in U.S. Pat. Nos. 3,615,972; 3,864,181; 4,006,273; 4,044,176; and 6,617,364 which are hereby incorporated, in their entirety, herein by reference. Further reference can be made to publish U.S. Patent Applications: 20010044477; 20030008931; 20030008932; and 20040157057, which are hereby incorporated, in their entirety, herein by reference. Microspheres may be prepared from polyvinylidene chloride, polyacrylonitrile, poly-alkyl methacrylates, polystyrene or vinyl chloride.

Microspheres may contain a polymer and/or copolymer that have a T_{g} ranging from −150° C. to +180° C., preferably from 50° C. to 150° C., most preferably from 75 to 125° C.

Microspheres may also contain at least one blowing agent which, upon application of an amount of heat energy, functions to provide internal pressure on the inside wall of the microsphere in a manner that such pressure causes the sphere to expand. Blowing agents may be liquids and/or gases. Further, examples of blowing agents may be selected from low boiling point molecules and compositions thereof. Such blowing agents may be selected from the lower alkanes such as neopentane, neohexane, hexane, propane, butane, pentane, and mixtures and isomers thereof. Isobutane is the preferred blowing agent for polyvinylidene chloride microspheres. Suitable coated unexpanded and expanded microspheres are disclosed in U.S. Pat. Nos. 4,722,943 and 4,829,094, which are hereby incorporated, in their entirety, herein by reference.

The expandable microspheres may have a mean diameter ranging from about 0.5 to 200 microns, preferably from 2 to 100 microns, most preferably from 5 to 40 microns in the unexpanded state and having a maximum expansion of from about 1.5 and 10 times, preferably from 2 to 10 times, most preferably from 2 to 5 times the mean diameters.

The expandable microspheres may be negatively or positively charged. Further, the expandable microspheres may be neutral. Still further, the expandable microspheres may be incorporated into a composition and/or particle of the present invention that has a net zeta potential that is greater than or equal to zero mV at a pH of about 9.0 or less at an ionic strength of from 10⁻⁶ M to 0.1M.

In the composition and/or particle of the present invention, the expandable microspheres may be neutral, negatively or positively charged, preferably negatively charged.

Further, the composition and/or particle of the present invention may contain expandable microspheres of the same physical characteristics disclosed above and below and may be incorporated into the paper substrate according to the present invention in the same manner and the same amounts as mentioned above and below for the expandable microspheres.

Still further, the composition and/or particle of the present invention may contain expandable microspheres and at least one ionic compound. When the composition and/or particle of the present invention contains expandable microspheres and at least one ionic compound, the composition and/or particle of the present invention that has a net zeta potential that is greater than or equal to zero mV at a pH of about 9.0 or less at an ionic strength of from 10⁻⁶ M to 0.1 M. Preferably, the net zeta potential is from greater than or equal to zero to +500, preferably greater than or equal to zero to +200, more preferably from greater than or equal to zero to +150, most preferably from +20 to +130, mV at a pH of about 9.0 or less at an ionic strength of from 10⁻⁶ M to 0.1 M as measured by standard and conventional methods of measuring zeta potential known in the analytical and physical arts, preferably methods utilizing microelectrophoresis at room temperature.

The ionic compound may be anionic and/or cationic, preferably cationic when the expandable microspheres are anionic. Further, the ionic compound may be organic, inorganic, and/or mixtures of both. Still further, the ionic compound may be in the form of a slurry and/or colloid. Finally, the ionic compound may have a particle size ranging 1 nm to 1 micron, preferably from 2 nm to 400 nm.

The ionic compound may be any of the optional substances and conventional additives mentioned below and/or commonly known in the art of papermaking. More preferably, the ionic compound may be any one or combination of the retention aids mentioned below.

The weight ratio of ionic compound to expandable microsphere in the composition and/or particle of the present invention may be from 1:500 to 500:1, preferably from 1:50 to 50:1, more preferably from 1:10 to 10:1, so long as the composition and/or particle has a net zeta potential that is greater than or equal to zero mV at a pH of about 9.0 or less at an ionic strength of from 10⁻⁶ M to 0.1 M.

The ionic compound may be inorganic. Examples of the inorganic ionic compound may contain, but are not limited to silica, alumina, tin oxide, zirconia, antimony oxide, iron oxide, and rare earth metal oxides. The inorganic may preferably be in the form of a slurry and/or colloid and/or sol when contacted with the expandable microsphere and have a particle size ranging from 1 nm to 1 micron, preferably from 2 nm, to 400 micron. When the inorganic ionic compound is in the form of a colloid and/or sol, the preferred compound contains silica and/or alumina.

The ionic compound may be organic. Examples of the ionic organic compound may be carbon-containing compounds. Further, the ionic organic compound may contain heteroatoms such as nitrogen, oxygen, and/or halogen. Still further, the ionic organic compound may contain a heteroatom-containing functional group such as hydroxy, amine, amide, carbony, carboxy, etc groups. Further the ionic organic compound may contain more that one positive charge, negative charge, or mixtures thereof. The ionic organic compound may be polymeric and/or copolymeric, which may further by cyclic, branched and/or crosslinked. When the ionic organic compound is polymeric and/or copolymeric, the compound preferably has a weight average molecular weight of from 600 to 5,000,000, more preferably from 1000 to 2,000,000, most preferably from 20,000 to 800,000 weight average molecular weight. Preferably, the ionic organic compound may be an amine containing compound. More preferably, the ionic organic compound may be a polyamine. Most preferably, the ionic organic compound may be a poly(DADMAC), poly(vinylamine), and/or a poly(ethylene imine).

The composition and/or particle of the present invention may contain at least one expandable microsphere and at least one ionic compound where the ionic compound is in contact with the outer surface of the expandable microsphere. Such contact may include a system where the expandable microsphere is coated and/or impregnated with the ionic compound. Preferably, while not wishing to be bound by theory, the ionic compound is bonded to the outside surface of the expandable microsphere by non-covalent inter molecular forces to form a particle having an inner expandable microsphere and outer ionic compound layered thereon. However, portions of the outer surface of the expandable microsphere layer may not be completely covered by the outer ionic compound layer, while portions of the outer surface of the expandable microsphere layer may actually be completely covered by the outer ionic compound layer. This may lead to some portions of the outer surface of the expandable microsphere layer being exposed.

The composition and/or particle of the present invention may be made by contacting, mixing, absorbing, adsorbing, etc, the expandable microsphere with the ionic compound. The relative amounts of expandable microsphere and ionic compound may be tailored by traditional means just as long as the as the resultant composition and/or particle has a net zeta potential that is greater than or equal to zero mV at a pH of about 9.0 or less at an ionic strength of from 10⁻⁶ to M to 0.1 M. Preferably, the weight ratio of ionic compound contacted with the expandable microsphere in the composition and/or particle of the present invention may be from 1:100 to 100:1, preferably from 1:80 to 80:1, more preferably from 1:1 to 1:60, most preferably from 1:2 to 1:50 so long as the composition and/or particle has a net zeta potential that is greater than or equal to zero mV at a pH of about 9.0 or less at an ionic strength of from 10⁻⁶ M to 0.1 M.

The present invention relates to a composition that may be added at any point during paper making, including at the size press. Accordingly, the composition may be a sizing composition.

The sizing composition may contain at least one inorganic salt at any amount. The sizing composition may contain from 0 to 99 wt %, preferably from 0.25 to 25 wt %, more preferably from 0.5 to 5, most preferably from 1 to 3 wt % of the inorganic salt based on the total weight of the solids in the composition. This range may include 0, 0.25, 0.5, 1, 2, 3, 4, 5, 10, 15, 20, 25, 30, 35, 40, 45, 50, 55, 60, 65, 70, 75, 80, 85, 90, 100 wt % based on the total weight of the solids in the composition, including any and all ranges and subranges contained therein. In a preferred embodiment, the sizing composition contains about 2.5 wt % of the inorganic salt based on the total weight of the solids in the composition.

The sizing composition may contain a binder. Examples of binders include, but are not limited to, polyvinyl alcohol, Amres (a Kymene type), Bayer Parez, polychloride emulsion, modified starch such as hydroxyethyl starch starch or derivatives thereof including cationic and oxidized forms and from corn and/or potato for example, polyacrylamide, modified polyacrylamide, polyol, polyol carbonyl adduct, ethanedial/polyol condensate, polyamide, epichlorohydrin, glyoxal glyoxal urea, ethanedial, aliphatic polyisocyanate, isocyanate, 1,6 hexamethylene diisocyanate, diisocyanate, polyisocyanate, polyester, polyester resin, polyacrylate, polyacrylate resin, acrylate, and methacrylate. While any combination of binders may be used, one embodiment includes a sizing composition containing starch or modifications thereof combined with polyvinyl alcohol as multi-component binder.

The sizing composition may contain a binder at any amount. The sizing composition may contain at least one binder from 0 to 99 wt %, preferably at least 10 wt %, more preferably at least 20 wt %, most preferably at least 30 wt % based on the total weight of the solids in the composition. This range may include 0, 1, 5, 10, 15, 20, 25, 30, 35, 40, 45, 50, 55, 60, 65, 70, 75, 80, 85, 90, 100 wt % based on the total weight of the solids in the composition, including any and all ranges and subranges contained therein. The most preferred being about 37 wt % binder based on the total weight of the solids in the composition.

The preferred binder is starch, modified starch, and derivatives of starch from any source, including woody and non-woody sources. When starch is present in the composition, the composition may be added in a manner that provides an I-beam structure. For example, a majority of the total amount of binder is preferably located at or near the outside surface or surfaces (in the case of the sizing applied to both surfaces) of the paper substrate. The paper substrate of the present invention contains the binder such that they (the substrate and the sizing agent) cooperate to form an I-beam structure. In this regard, it is not required that the sizing agent interpenetrate with the cellulosic fibers of the substrate. However, if the coating layer and the cellulose fibers interpenetrate, it will create a paper substrate having an interpenetration layer, which is within the ambit of the present invention.

The interpenetration layer of the paper substrate defines a region in which at least the sizing solution penetrates into and is among the cellulose fibers. The interpenetration layer may be from 1 to 99% of the entire cross section of at least a portion of the paper substrate, including 1, 2, 5, 10, 15, 20, 25, 30, 35, 40, 45, 50, 55, 60, 65, 70, 75, 80, 85, 90, 95, and 99% of the paper substrate, including any and all ranges and subranges therein. Such an embodiment may be made, for example, when a sizing solution is added to the cellulose fibers prior to a coating method and may be combined with a subsequent coating method if required. Addition points may be at the size press, for example.

Preferably, the cross-sectional thickness of the interpenetration layer is minimized. Alternatively, or additionally, the concentration of the binder preferably increases as one moves (in the z-direction normal to the plane of the substrate) from the interior portion towards the surface of the paper substrate. Therefore, the amount of binder present towards the top and/or bottom outer surfaces of the substrate is preferably greater than the amount of binder present towards the inner middle of paper substrate. Alternatively, a majority percentage of the binder may preferably be located at a distance from the outside surface of the substrate that is equal to or less than 25%, more preferably 10%, of the total thickness of the substrate. This aspect may also be known as the Qₜₒₜₐₗ, which is measured by known methodologies outlined, for example, in U.S. Patent Publication No. 2008/0035292, published Feb. 14, 2008, the entire contents of which are hereby incorporated by reference. If Qₜₒₜₐₗ is equal to 0.5, then the binder is approximately evenly distributed throughout the paper substrate. If Qₜₒₜₐₗ is greater than 0.5, then there is more binder towards the central portion (measured by the z-direction normal to the plane of the substrate) of the paper substrate than towards the paper substrate's surface or surfaces. If Qₜₒₜₐₗ is less than 0.5, then there is less binder towards the central portion of the paper substrate than towards the paper substrate's surface or surfaces. In light of the above, the paper substrate preferably has a Qₜₒₜₐₗ that is less than 0.5, preferably less than 0.4, more preferably less than 0.3, most preferably less than 0.25. Accordingly the Qₜₒₜₐₗ of the paper substrate may be from 0 to less than 0.5. This range includes 0, 0.001, 0.002, 0.005, 0.01, 0.02, 0.05, 0.1, 0.15, 0.2, 0.25, 0.3, 0.35, 0.4, 0.45, and 0.49, including any and all ranges and subranges therein.

As noted above, the determination of Q may be suitably carried out according to the procedures in U.S. Patent Publication 2008/0035292, published Feb. 14, 2008.

In essence, Q is a measurement of the amount of the starch as one progresses from the outside edges towards the middle of the sheet from a cross section view. It is understood herein that the Q may be any Q such that it represents an enhanced capacity to have starch towards the outside surfaces of the cross section of the sheet and Q may be selected (using any test) such that any one or more of the above and below-mentioned characteristics of the paper substrate are provided (e.g. Internal Bond, Hygroexpansivity, IGT Pick, and/or IGT VPP delamination, etc).

Of course, there are other methods to measuring the equivalent of Q. In one embodiment, any Q measurement, or a similar method of measuring the ratio of the amount of binder towards the core of the substrate compared to the amount of binder towards the outside surface or surfaces of the substrate is acceptable. In a preferred embodiment, this ratio is such that as much binder as possible is located towards the outside surfaces of the substrate, thereby minimizing the interpenetration zone and/or minimizing the amount of starch located in the interpenetration layer, is achieved. It is also preferable that this distribution of binder occurs even at very high level of binder loadings, preferably external binder loadings, within and/or onto the substrate. Thus, it is desirable to control the amount of binder located within the interpenetration layer as more and more external binder is loaded thereon its surface by either minimizing the concentration of the binder in this interpenetration layer or by reducing the thickness of the interpenetration layer itself. In one embodiment, the characteristics of the recording sheet and/or paper substrate of the present invention are those that can be achieved by such control of the binder. While this controlled loading of the binder can occur in any manner, it is preferable that the binder is loaded or applied via a size press.

The sizing composition may contain at least one optical brightening agent (OBA). Suitable OBAs may be those mentioned in U.S. Ser. No. 60/654,712 filed Feb. 19, 2005, and U.S. Pat. No. 6,890,454, which are hereby incorporated, in their entirety, herein by reference. The OBAs may be commercially available from Clariant. Further, the OBA may be either cationic and/or anionic. Example OBA is that commercially available Leucophore BCW and Leucophore FTS from Clariant. In one embodiment, the OBA contained in the sizing composition is cationic.

The sizing composition may contain any amount of at least one anionic OBA. The sizing composition may contain anionic OBA at an amount from 0 to 99 wt %, preferably from 5 to 75 wt %, more preferably from 10 to 50 wt %, most preferably from 20 to 40 wt % based on the total weight of the solids in the composition. This range may include 0, 1, 5, 10, 15, 20, 25, 30, 35, 40, 45, 50, 55, 60, 65, 70, 75, 80, 85, 90, 99 wt % anionic OBA based on the total weight of the solids in the composition, including any and all ranges and subranges contained therein. In a preferred embodiment, the sizing composition contains about 35 wt % of anionic OBA based on the total weight of the solids in the composition.

The sizing composition may contain any amount of at least one cationic OBA. The sizing composition may contain cationic OBA at an amount from 0 to 99 wt %, preferably from 0.5 to 25 wt %, more preferably from 1 to 20 wt %, most preferably from 5 to 15 wt % based on the total weight of the solids in the composition. This range may include 0, 1, 5, 10, 15, 20, 25, 30, 35, 40, 45, 50, 55, 60, 65, 70, 75, 80, 85, 90, 99 wt % anionic OBA based on the total weight of the solids in the composition, including any and all ranges and subranges contained therein. In a preferred embodiment, the sizing composition contains about 8 wt % of cationic OBA based on the total weight of the solids in the composition.

If desired, the recording sheet contains at least one sizing agent in addition to the composition. The sizing agent is not particularly limited, and any conventional papermaking sizing agent may be used. The sizing agent may be nonreactive, reactive, or a combination of nonreactive and reactive. The sizing agent may, optionally and if desired, impart a moisture or water-resistance in varying degrees to the paper substrate. Non-limiting examples of sizing agents can be found in the “Handbook for Pulp and Paper Technologists” by G. A. Smook (1992), Angus Wilde Publications, which is hereby incorporated, in its entirety, by reference. Preferably, the sizing agent is a surface sizing agent. Preferable examples of sizing agents are starch, alkyl ketene dimer (AKD), alkenyl ketene dimer (ALKD), alkenyl succinic anhydride (ASA), ASA/ALKD, styrene acrylic emulsion (SAE) polyvinyl alcohol (PVOH), polyvinylamine, alginate, carboxymethyl cellulose, etc. However, any sizing agent may be used. See, for example, the sizing agents disclosed in U.S. Pat. No. 6,207,258, the entire contents of which are hereby incorporated by reference.

Many nonreactive sizing agents are known in the art. Examples include, without limitation, BASOPLAST® 335D nonreactive polymeric surface size emulsion from BASF Corporation (Mt. Olive, N.J.), FLEXBOND® 325 emulsion of a copolymer of vinyl acetate and butyl acrylate from Air Products and Chemicals, Inc. (Trexlertown, Pa.), and PENTAPRINT® nonreactive sizing agents (disclosed for example in Published International Patent Application Publication No. WO 97/45590, published Dec. 4, 1997, corresponding to U.S. patent application Ser. No. 08/861,925, filed May 22, 1997, the entire contents of which are hereby incorporated by reference) from Hercules Incorporated (Wilmington, Del.), to name a few.

For papermaking carried out under alkaline pH manufacturing conditions, sizing agents based on alkyl ketene dimers (AKDs) or alkenyl ketene dimers (ALKDs) or multimers and alkenyl succinic anhydride (ASA) sizing agents may be suitably used. Combinations of these and other sizing agents may also be employed.

Ketene dimers used as sizing agents for papermaking are well known. AKDs, containing one β-lactone ring, are typically prepared by the dimerization of alkyl ketenes made from two fatty acid chlorides. Commercial alkyl ketene dimer sizing agents are often prepared from palmitic and/or stearic fatty acids, e.g. Hercon® and Aquapel® sizing agents (both from Hercules Incorporated).

Alkenyl ketene dimer sizing agents are also commercially available, e.g. Precis® sizing agents (Hercules Incorporated).

U.S. Pat. No. 4,017,431, the entire contents of which are hereby incorporated by reference, provides a nonlimiting exemplary disclosure of AKD sizing agents with wax blends and water soluble cationic resins.

Ketene multimers containing more than one β-lactone ring may also be employed as sizing agents.

Sizing agents prepared from a mixture of mono- and dicarboxylic acids, have been disclosed as sizing agents for paper in Japanese Kokai Nos. 168991/89 and 168992/89.

European patent application Publication No. 0 629 741 A1 discloses alkyl ketene dimer and multimer mixtures as sizing agents in paper used in high speed converting and reprographic machines. The alkyl ketene multimers are made from the reaction of a molar excess of monocarboxylic acid, typically a fatty acid, with a dicarboxylic acid. These multimer compounds are solids at 25° C. European patent application Publication No. 0 666 368 A2 and Bottorff et al., in U.S. Pat. No. 5,685,815, the entire contents of which are hereby incorporated by reference, disclose paper for high speed or reprographic operations that is internally sized with an alkyl or alkenyl ketene dimer and/or multimer sizing agent. The preferred 2-oxetanone multimers are prepared with fatty acid to diacid ratios ranging from 1:1 to 3.5:1.

Commercial ASA-based sizing agents are dispersions or emulsions of materials that may be prepared by the reaction of maleic anhydride with an olefin (C₁₄-C₁₈).

Examples of hydrophobic acid anhydrides useful as sizing agents for paper include:

(i) rosin anhydride (see U.S. Pat. No. 3,582,464, for example, the entire contents of which are hereby incorporated by reference);
(ii) anhydrides having the structure (I):

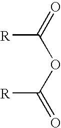

where each R is the same or a different hydrocarbon radical; and
(iii) cyclic dicarboxylic acid anhydrides, such as those having the structure (II):

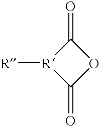

where R′ represents a dimethylene or trimethylene radical and where R″ is a hydrocarbon radical. Some examples of anhydrides of formula (I) include myristoyl anhydride; palmitoyl anhydride; olcoyl anhydride; and stearoyl anhydride. Examples of substituted cyclic dicarboxylic acid anhydrides falling within the above formula (II) include substituted succinic, glutaric anhydrides, i- and n-octadecenyl succinic acid anhydride; i- and n-hexadecenyl succinic acid anhydride; i- and n-tetradecenyl succinic acid anhydride, dodecyl succinic acid anhydride; decenyl succinic acid anhydride; ectenyl succinic acid anhydride; and heptyl glutaric acid anhydride.

Other examples of nonreactive sizing agents include a polymer emulsion, a cationic polymer emulsion, an amphoteric polymer emulsion, polymer emulsion wherein at least one monomer is selected from the group including styrene, α-methylstyrene, acrylate with an ester substituent with 1 to 13 carbon atoms, methacrylate having an ester substituent with 1 to 13 carbon atoms, acrylonitrile, methacrylonitrile, vinyl acetate, ethylene and butadiene; and optionally including acrylic acid, methacrylic acid, maleic anhydride, esters of maleic anhydride or mixtures thereof, with an acid number less than about 80, and mixtures thereof.

The present invention also relates to a paper substrate containing any of the sizing compositions described above.

The paper substrate contains a web of cellulose fibers. The source of the fibers may be from any fibrous plant. The paper substrate of the present invention may contain recycled fibers and/or virgin fibers. Recycled fibers differ from virgin fibers in that the fibers have gone through the drying process at least once.

The paper substrate of the present invention may contain from 1 to 99 wt %, preferably from 5 to 95 wt %, most preferably from 60 to 80 wt % of cellulose fibers based upon the total weight of the substrate, including 1, 5, 10, 15, 20, 25, 30, 35, 40, 45, 50, 55, 60, 65, 70, 75, 80, 85, 90, 95 and 99 wt %, and including any and all ranges and subranges therein.

While the fiber source may be any, the preferable sources of the cellulose fibers are from softwood and/or hardwood. The paper substrate of the present invention may contain from 1 to 100 wt %, preferably from 5 to 95 wt %, cellulose fibers originating from softwood species based upon the total amount of cellulose fibers in the paper substrate. This range includes 1, 2, 5, 10, 15, 20, 25, 30, 35, 40, 45, 50, 55, 60, 65, 70, 75, 80, 85, 90, 95, and 100 wt %, including any and all ranges and subranges therein, based upon the total amount of cellulose fibers in the paper substrate.

The paper substrate of the present invention may contain from 1 to 100 wt %, preferably from 5 to 95 wt %, cellulose fibers originating from hardwood species based upon the total amount of cellulose fibers in the paper substrate. This range includes 1, 2, 5, 10, 15, 20, 25, 30, 35, 40, 45, 50, 55, 60, 65, 70, 75, 80, 85, 90, 95, and 100 wt %, including any and all ranges and subranges therein, based upon the total amount of cellulose fibers in the paper substrate.

When the paper substrate contains both hardwood and softwood fibers, it is preferable that the hardwood/softwood ratio be from 0.001 to 1000. This range may include 0.001, 0.002, 0.005, 0.01, 0.02, 0.05, 0.1, 0.2, 0.5, 1, 2, 5, 10, 15, 20, 25, 30, 35, 40, 45, 50, 55, 60, 65, 70, 75, 80, 85, 90, 95, 100, 200, 300, 400, 500, 600, 700, 800, 900, and 1000 including any and all ranges and subranges therein and well as any ranges and subranges therein the inverse of such ratios.

Further, the softwood and/or hardwood fibers contained by the paper substrate of the present invention may be modified by physical and/or chemical means. Examples of physical means include, but is not limited to, electromagnetic and mechanical means. Means for electrical modification include, but are not limited to, means involving contacting the fibers with an electromagnetic energy source such as light and/or electrical current. Means for mechanical modification include, but are not limited to, means involving contacting an inanimate object with the fibers. Examples of such inanimate objects include those with sharp and/or dull edges. Such means also involve, for example, cutting, kneading, pounding, impaling, etc means.

Examples of chemical means include, but is not limited to, conventional chemical fiber modification means including crosslinking and precipitation of complexes thereon. Examples of such modification of fibers may be, but is not limited to, those found in the following U.S. Pat. Nos. 6,592,717, 6,592,712, 6,582,557, 6,579,415, 6,579,414, 6,506,282, 6,471,824, 6,361,651, 6,146,494, H1,704, 5,731,080, 5,698,688, 5,698,074, 5,667,637, 5,662,773, 5,531,728, 5,443,899, 5,360,420, 5,266,250, 5,209,953, 5,160,789, 5,049,235, 4,986,882, 4,496,427, 4,431,481, 4,174,417, 4,166,894, 4,075,136, and 4,022,965, which are hereby incorporated, in their entirety, herein by reference. Further modification of fibers is found in United States patent applications having Application No. 60/654,712 filed Feb. 19, 2005; Ser. No. 11/358,543 filed Feb. 21, 2006; Ser. No. 11/445,809 filed Jun. 2, 2006; and Ser. No. 11/446,421 filed Jun. 2, 2006, which may include the addition of optical brighteners (i.e. OBAs) as discussed therein, which are hereby incorporated, in their entirety, herein by reference.

One example of a recycled fiber is a “fine”. Sources of “fines” may be found in SaveAll fibers, recirculated streams, reject streams, waste fiber streams. The amount of “fines” present in the paper substrate can be modified by tailoring the rate at which such streams are added to the paper making process.

The paper substrate preferably contains a combination of hardwood fibers, softwood fibers and “fines” fibers. “Fines” fibers are, as discussed above, recirculated and are any length. Fines may typically be not more that 100 μm in length on average, preferably not more than 90 μm, more preferably not more than 80 μm in length, and most preferably not more than 75 μm in length. The length of the fines are preferably not more than 5, 10, 15, 20, 25, 30, 35, 40, 45, 50, 55, 60, 65, 70, 75, 80, 85, 90, 95, and 100 μm in length, including any and all ranges and subranges therein.

The paper substrate may contain fines at any amount. The paper substrate may contain from 0.01 to 100 wt % fines, preferably from 0.01 to 50 wt %, most preferably from 0.01 to 15 wt % based upon the total weight of the fibers contained by the paper substrate. The paper substrate contains not more than 0.01, 0.05, 0.1, 0.2, 0.5, 1, 2, 3, 4, 5, 6, 7, 8, 9, 10, 12, 15, 20, 25, 30, 35, 40, 45, 50, 55, 60, 65, 70, 75, 80, 85, 90, 95 and 100 wt % fines based upon the total weight of the fibers contained by the paper substrate, including any and all ranges and subranges therein.

The paper substrate may also contain an internal sizing and/or external sizing composition. The internal sizing composition may be applied to the fibers during papermaking at the wet end, while the external sizing composition may be applied to the fibers via a size press and/or coater. The above mentioned sizing compositions of the present invention may be the internal and/or external sizing composition contained by the paper substrate of the present invention.

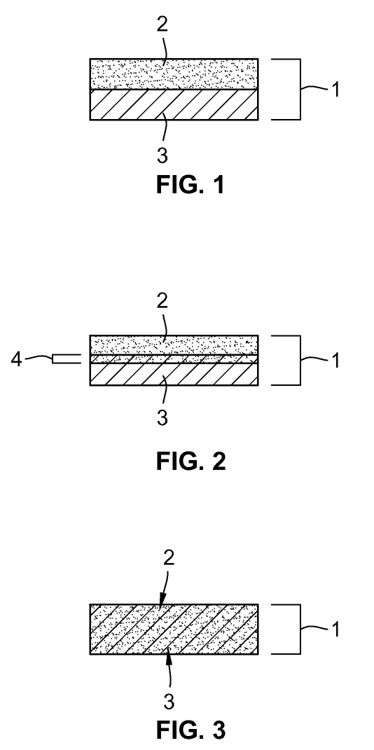

FIGS. 1-3 demonstrate different embodiments of the paper substrate 1 in the paper substrate of the present invention. FIG. 1 demonstrates a paper substrate 1 that has a web of cellulose fibers 3 and a sizing composition 2 where the sizing composition 2 has minimal interpenetration of the web of cellulose fibers 3. Such an embodiment may be made, for example, when a sizing composition is coated onto a web of cellulose fibers.

FIG. 2 demonstrates a paper substrate 1 that has a web of cellulose fibers 3 and a sizing composition 2 where the sizing composition 2 interpenetrates the web of cellulose fibers 3. The interpenetration layer 4 of the paper substrate 1 defines a region in which at least the sizing solution penetrates into and is among the cellulose fibers. The interpenetration layer may be from 1 to 99% of the entire cross section of at least a portion of the paper substrate, including 1, 2, 5, 10, 15, 20, 25, 30, 35, 40, 45, 50, 55, 60, 65, 70, 75, 80, 85, 90, 95, and 99% of the paper substrate, including any and all ranges and subranges therein. Such an embodiment may be made, for example, when a sizing composition is added to the cellulose fibers prior to a coating method and may be combined with a subsequent coating method if required. Addition points may be at the size press, for example.

FIG. 3 demonstrates a paper substrate 1 that has a web of cellulose fibers 3 and a sizing solution 2 where the sizing composition 2 is approximately evenly distributed throughout the web of cellulose fibers 3. Such an embodiment may be made, for example, when a sizing composition is added to the cellulose fibers prior to a coating method and may be combined with a subsequent coating method if required. Exemplified addition points may be at the wet end of the paper making process, the thin stock, and the thick stock.

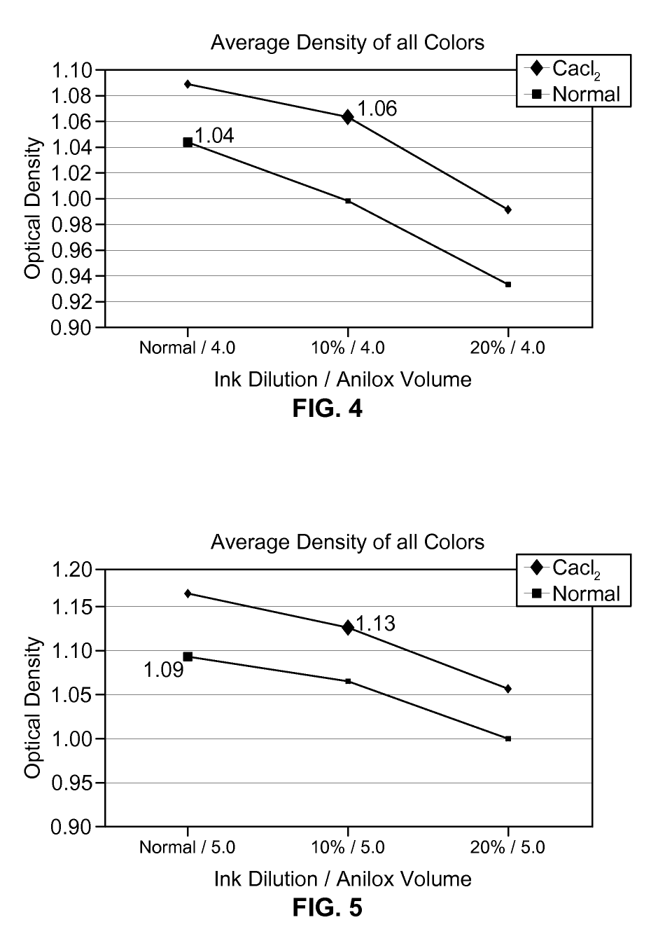

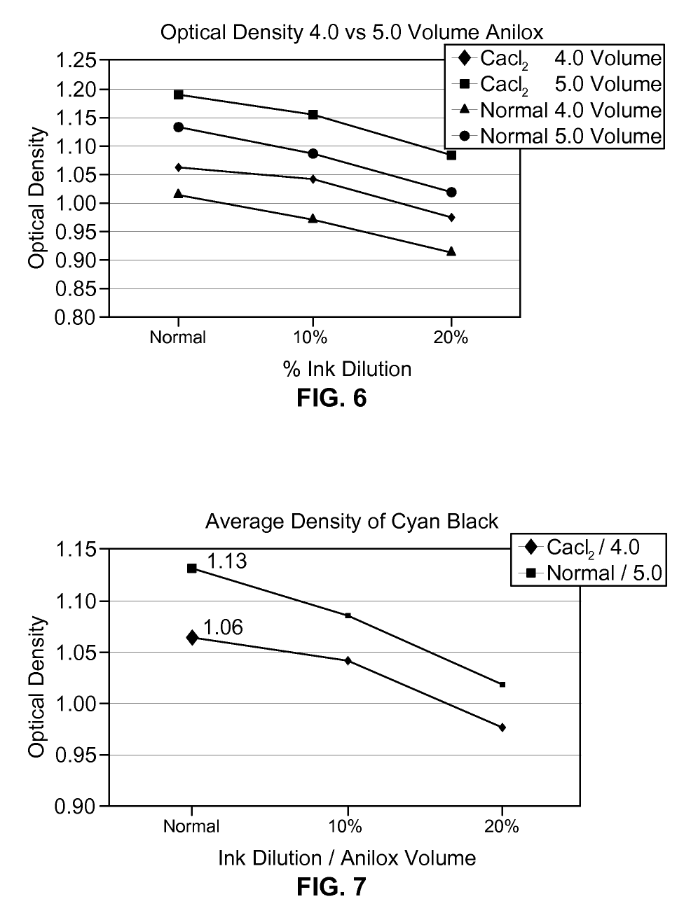

In FIGS. 4-7, the following are resulted: 1) the Calcium Chloride treated paper exhibited approximately 5.5% higher optical print densities than non-Calcium Chloride treated paper, using two different inks such as Fluid ink A and Fluid ink B; 2) Ink diluted 10% with water exhibited around 2.5% higher optical print densities than non-Calcium Chloride printed with non-diluted ink and printed ink colour intensity or shade will change; 3) the Calcium Chloride treated paper printed with 4.0 volume anilox showed a 5% reduction in optical density verses a non-treated sheet printed with a 5.0 volume anilox. When anilox volume was reduced from 5.0 to 4.0, printed optical density diminished by 10% when measured on the same grade of paper. 4) There is no conclusive evidence that Calcium Chloride treated paper effects mottle. 5) Calcium Chloride treated paper exhibited no difference in dry time or press tracking than non-Calcium Chloride treated paper, using two different inks such as Fluid ink and Inx ink and when diluting these inks with 10% or 20% water. 6) Calcium Chloride treated paper exhibited higher hygro-expansivity in the CD direction.

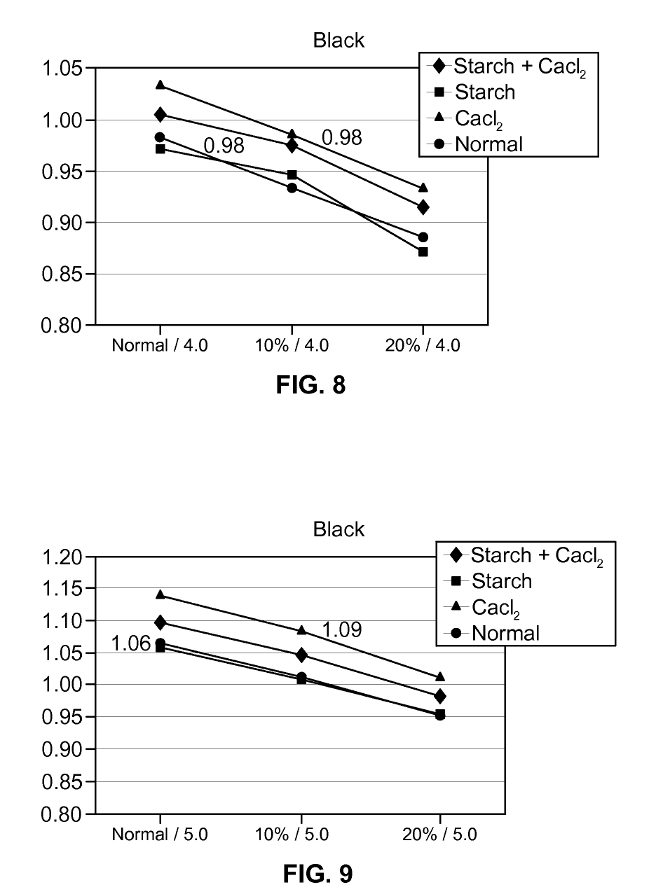

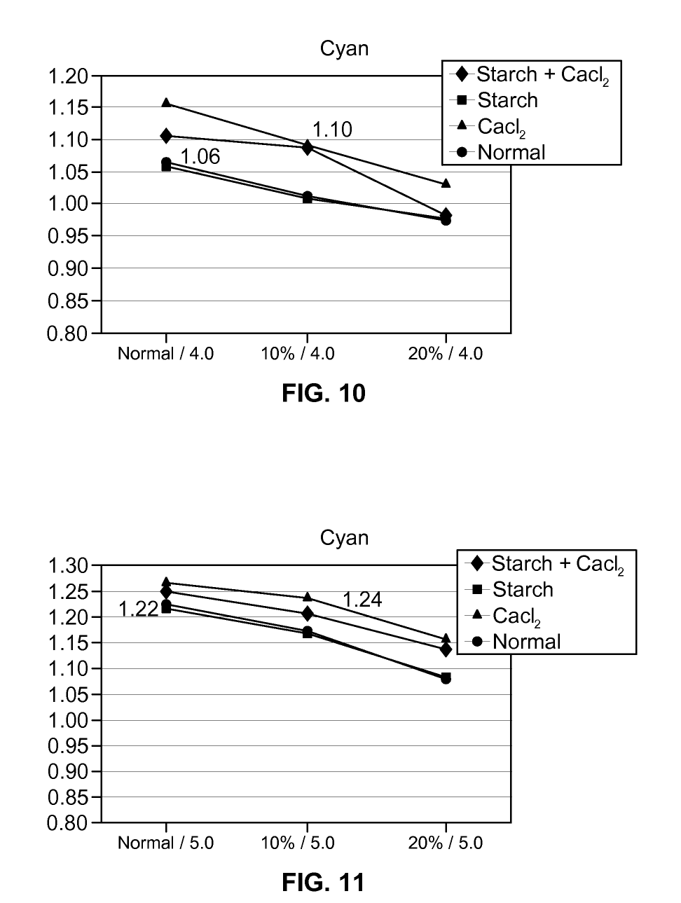

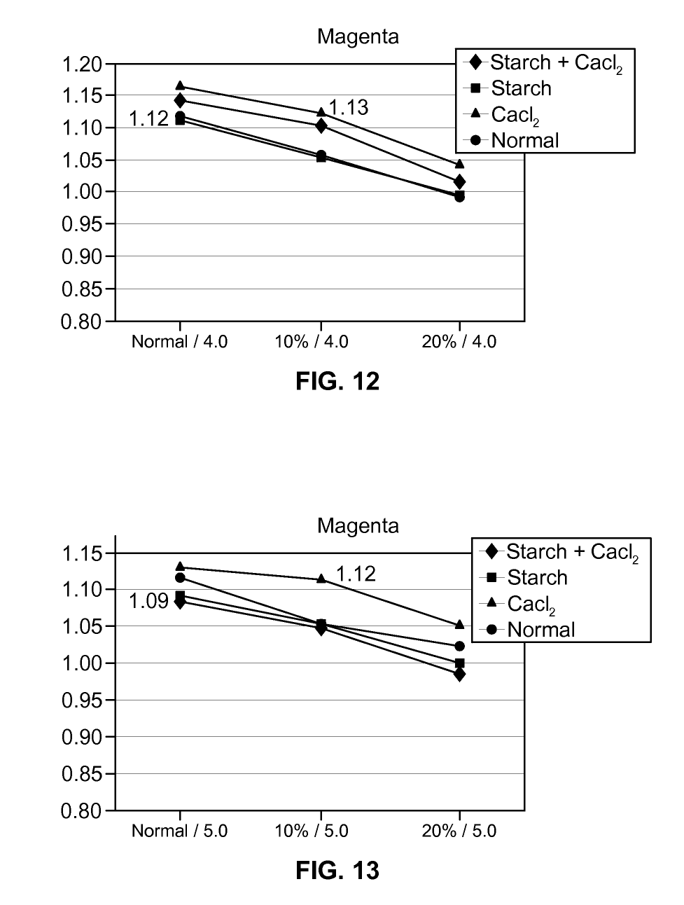

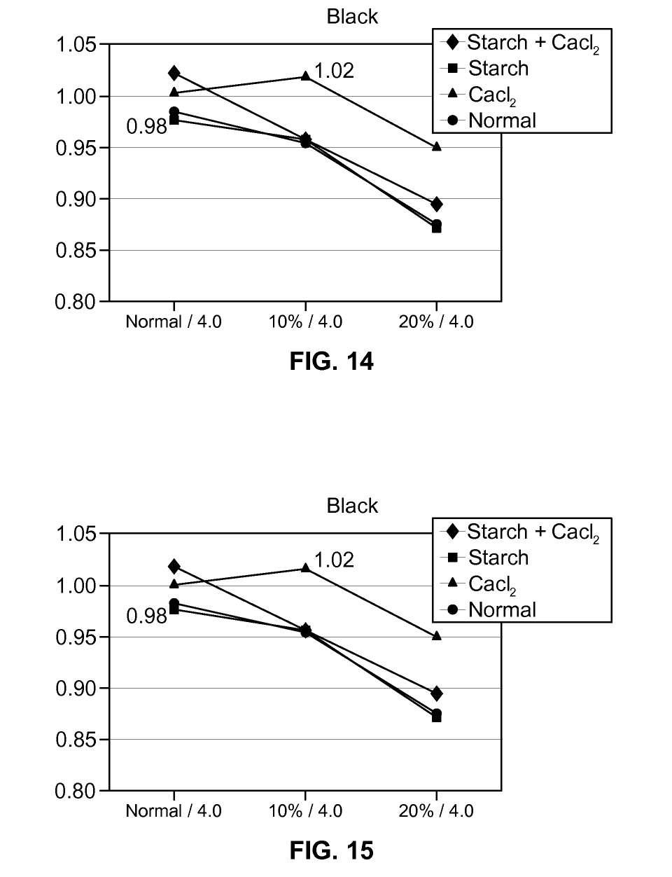

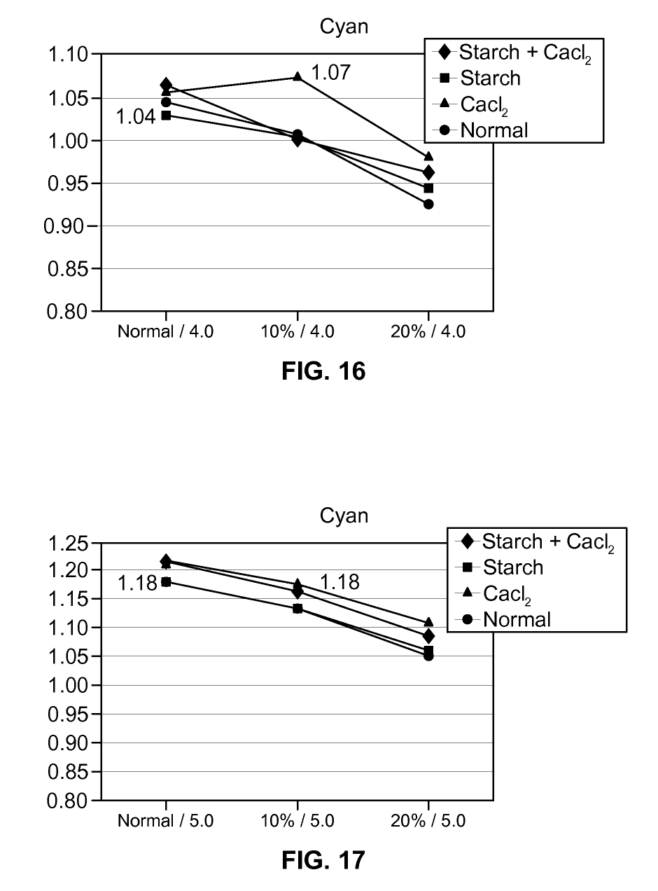

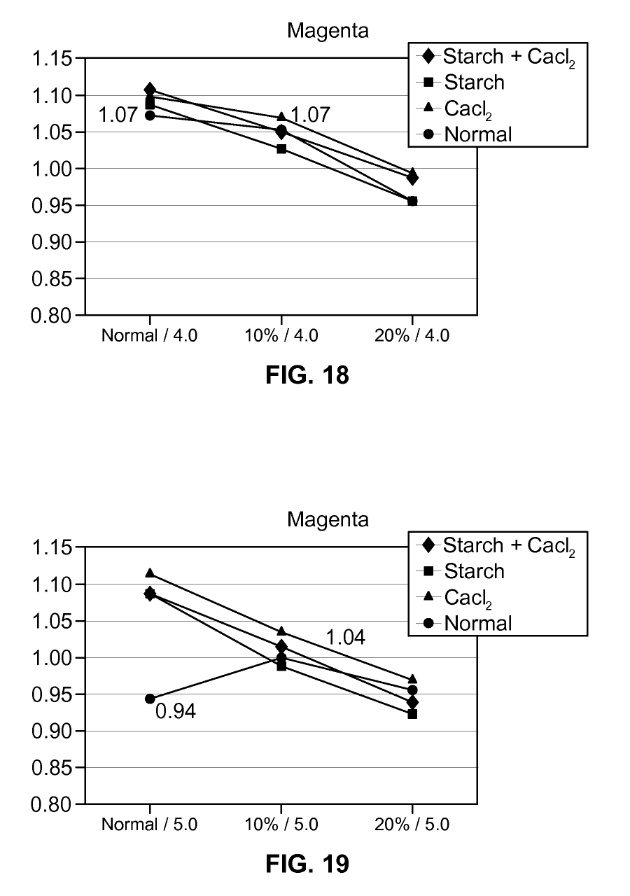

FIGS. 8-19 are additional Calcium Chloride treated paper that will be flexography printed to verify the benefit thereof.

The paper substrate may be made by contacting any component of the sizing solution with the cellulose fibers consecutively and/or simultaneously. Still further, the contacting may occur at acceptable concentration levels that provide the paper substrate of the present invention to contain any of the above-mentioned amounts of cellulose and components of the sizing solution. The contacting may occur anytime in the papermaking process including, but not limited to the thick stock, thin stock, head box, and coater with the preferred addition point being at the thin stock. Further addition points include machine chest, stuff box, and suction of the fan pump. Preferably, the components of the sizing solution are preformulated either together and/or in combination within a single and/or separate coating layer(s) and coated onto the fibrous web via a size press and/or coater.

The paper or paperboard of this invention can be prepared using known conventional techniques. Methods and apparatuses for forming and making and applying a coating formulation to a paper substrate are well known in the paper and paperboard art. See for example, G. A. Smook referenced above and references cited therein all of which is hereby incorporated by reference. All such known methods can be used in the practice of this invention and will not be described in detail.

The paper substrate may contain the sizing composition at any amount. The paper substrate may contain the sizing composition at an amount ranging from 70 to 300 lbs/ton of paper, preferably from 80 to 250 lbs/ton of paper, more preferably from 100 to 200 lbs/ton of paper, most preferably from 125 to 175 lbs/ton of paper. This range includes, 70, 80, 90, 100, 110, 120, 130, 135, 140, 150, 160, 170, 180, 190, 200, 210, 220, 230, 240, 250, 260, 270 280, 290, and 300 lbs/ton of paper, including any and all ranges and subranges therein. In a preferred embodiment the paper substrate contains a size press applied sizing composition at an amount of from 130 to 150 lbs/ton of paper substrate.

Given the above mentioned preferred amounts of sizing composition contained in the substrate of the present invention, combined with the above-mentioned amounts of inorganic salt; the amounts of each of the inorganic salt that are contained in the paper may be easily calculated. For example, if 50 wt % of inorganic salt is present in the sizing solution based upon the total weight of solids in the composition, and the paper substrate contains 150 lbs of the sizing composition/ton, then the paper substrate contains 50%×150 lbs/ton of paper=75 lbs inorganic salt/ton of paper, which is 75 lbs/2000 lbs×100=3.75 wt % inorganic salt based upon the total weight of the paper substrate.

With respect to the inorganic salt, any amount of inorganic salt may be added to the paper so as to have the above and below described properties bestowed on the paper. For example, the paper may have at least 2 lbs/ton, at least 4, at least 6, at least 10, at least 15, at least 20 and at least 30 lbs/ton of paper added thereto the substrate. The amount of inorganic salt added to the paper may be at least 2, 3, 4, 5, 6, 7, 8, 9, 10, 11, 12, 13, 14, 15, 16, 17, 18, 19, 20, 25, and 30 lbs/ton of paper, including any and all ranges and subranges therein.

After the sizing composition is added to the paper, the paper may contain/retain at least 2 lbs/ton, at least 4, at least 6, at least 10, at least 15, at least 20 and at least 30 lbs of inorganic salt/ton of paper. The amount of inorganic salt contained/retained in and/or on the paper may be at least 2, 3, 4, 5, 6, 7, 8, 9, 10, 11, 12, 13, 14, 15, 16, 17, 18, 19, 20, 25, and 30 lbs/ton of paper, including any and all ranges and subranges therein. However, any amount of inorganic salt may be an “effective amount” so long as the amount in and/or on the paper is able to bestow any one or more of the below or above-described properties of the paper substrate.

The density, basis weight and caliper of the web of this invention may vary widely and conventional basis weights, densities and calipers may be employed depending on the paper-based product formed from the web. Paper or paperboard of invention preferably have a final caliper, after calendering of the paper, and any nipping or pressing such as may be associated with subsequent coating of from about 1 mils to about 35 mils although the caliper can be outside of this range if desired. More preferably the caliper is from about 4 mils to about 20 mils, and most preferably from about 7 mils to about 17 mils. The caliper of the paper substrate with or without any coating may be 1, 2, 3, 4, 5, 6, 7, 8, 9, 10, 11, 12, 13, 14, 15, 17, 20, 22, 25, 27, 30, 32, and 35, including any and all ranges and subranges therein.

Paper substrates of the invention preferably exhibit basis weights of from about 10 lb/3000 ft² to about 500 lb/3000 ft², although web basis weight can be outside of this range if desired. More preferably the basis weight is from about 30 lb/3000 ft² to about 200 lb/3000 ft², and most preferably from about 35 lb/3000 ft² to about 150 lb/3000 ft². The basis weight may be 10, 12, 15, 17, 20, 22, 25, 30, 32, 35, 37, 40, 45, 50, 55, 60, 65, 70, 75, 80, 85, 90, 95, 100, 110, 120, 130, 140, 150, 160, 170, 180, 190, 200, 225, 250, 275, 300, 325, 350, 375, 400, 425, 450, 500 lb/3000 ft², including any and all ranges and subranges therein.

In another embodiment, the substrate according to the present invention may have a basis weight of from 12 to 46 lb per 1300 square feet, preferably from 16 to 42 lb per 1300 square feet, most preferably from 18 to 40 lb per 1300 square feet. If the substrate is a coated substrate, the preferred basis weights are from 24 to 40 lbs per 1300 square feet. If the substrate is uncoated the preferred basis weights are from 18 to 28 lbs per 1300 square feet.

The final density of the papers may be calculated by any of the above-mentioned basis weights divided by any of the above-mentioned calipers, including any and all ranges and subranges therein. Preferably, the final density of the papers, that is, the basis weight divided by the caliper, is preferably from about 6 lb/3000 ft²/mil to about 14 lb/3000 ft²/mil although web densities can be outside of this range if desired. More preferably the web density is from about 7 lb/3000 ft²/mil to about 13 lb/3000 ft²/mil and most preferably from about 9 lb/3000 ft²/mil to about 12 lb/3000 ft²/mil.

The web may also include other conventional additives such as, for example, starch, expandable microspheres, mineral fillers, bulking agents, sizing agents, retention aids, and strengthening polymers. Among the fillers that may be used are organic and inorganic pigments such as, by way of example, polymeric particles such as polystyrene latexes and polymethylmethacrylate, and minerals such as calcium carbonate, kaolin, and talc. Other conventional additives include, but are not restricted to, wet strength resins, internal sizes, dry strength resins, alum, fillers, pigments and dyes. Internal sizing helps prevent the surface size from soaking into the sheet, thus allowing it to remain on the surface where it has maximum effectiveness. The internal sizing agents encompass any of those commonly used at the wet end of a paper machine. These include rosin sizes, ketene dimers and multimers, and alkenylsuccinic anhydrides. The internal sizes are generally used at levels of from about 0.00 wt. % to about 0.25 wt. % based on the weight of the dry paper sheet. Methods and materials utilized for internal sizing with rosin are discussed by E. Strazdins in The Sizing of Paper, Second Edition, edited by W. F. Reynolds, Tappi Press, 1989, pages 1-33. Suitable ketene dimers for internal sizing are disclosed in U.S. Pat. No. 4,279,794, which is incorporated by reference in its entirety, and in United Kingdom Patent Nos. 786,543; 903,416; 1,373,788 and 1,533,434, and in European Patent Application Publication No. 0666368 A3. Ketene dimers are commercially available, as Aquapel® and Precis® sizing agents from Hercules Incorporated, Wilmington, Del. Ketene multimers for use in internal sizes are described in: European Patent Application Publication No. 0629741A1, corresponding to U.S. patent application Ser. No. 08/254,813, filed Jun. 6, 1994; European Patent Application Publication No. 0666368A3, corresponding to U.S. patent application Ser. No. 08/192,570, filed Feb. 7, 1994; and U.S. patent application Ser. No. 08/601,113, filed Feb. 16, 1996. Alkenylsuccinic anhydrides for internal sizing are disclosed in U.S. Pat. No. 4,040,900, which in incorporated herein by reference in its entirety, and by C. E. Farley and R. B. Wasser in The Sizing of Paper, Second Edition, edited by W. F. Reynolds, Tappi Press, 1989, pages 51-62. A variety of alkenylsuccinic anhydrides are commercially available from Albemarle Corporation, Baton Rouge, La.

The paper substrate may be made by contacting further optional substances with the cellulose fibers as well. The contacting of the optional substances and the cellulose fibers may occur anytime in the papermaking process including, but not limited to the thick stock, thin stock, head box, size press, water box, and coater. Further addition points include machine chest, stuff box, and suction of the fan pump. The cellulose fibers, components of the sizing composition, and/or optional components may be contacted serially, consecutively, and/or simultaneously in any combination with each other. The cellulose fibers components of the sizing composition may be pre-mixed in any combination before addition to or during the paper-making process.

The paper substrate may be pressed in a press section containing one or more nips. However, any pressing means commonly known in the art of papermaking may be utilized. The nips may be, but is not limited to, single felted, double felted, roll, and extended nip in the presses. However, any nip commonly known in the art of papermaking may be utilized.

The paper substrate may be dried in a drying section. Any drying means commonly known in the art of papermaking may be utilized. The drying section may include and contain a drying can, cylinder drying, Condebelt drying, IR, or other drying means and mechanisms known in the art. The paper substrate may be dried so as to contain any selected amount of water. Preferably, the substrate is dried to contain less than or equal to 10% water.

The paper substrate may be passed through a size press, where any sizing means commonly known in the art of papermaking is acceptable. The size press, for example, may be a puddle mode size press (e.g. inclined, vertical, horizontal) or metered size press (e.g. blade metered, rod metered). At the size press, sizing agents such as binders may be contacted with the substrate. Optionally these same sizing agents may be added at the wet end of the papermaking process as needed. After sizing, the paper substrate may or may not be dried again according to the above-mentioned exemplified means and other commonly known drying means in the art of papermaking. The paper substrate may be dried so as to contain any selected amount of water. Preferably, the substrate is dried to contain less than or equal to 10% water. Preferably, the sizing apparatus is a puddle size press.

The paper substrate may be calendered by any commonly known calendaring means in the art of papermaking. More specifically, one could utilize, for example, wet stack calendering, dry stack calendering, steel nip calendaring, hot soft calendaring or extended nip calendering, etc. While not wishing to be bound by theory, it is thought that the presence of the expandable microspheres and/or composition and/or particle of the present invention may reduce and alleviate requirements for harsh calendaring means and environments for certain paper substrates, dependent on the intended use thereof.

The paper substrate may be microfinished according to any microfinishing means commonly known in the art of papermaking. Microfinishing is a means involving frictional processes to finish surfaces of the paper substrate. The paper substrate may be microfinished with or without a calendering means applied thereto consecutively and/or simultaneously. Examples of microfinishing means can be found in United States Published Patent Application 20040123966 and references cited therein, as well as U.S. Ser. No. 60/810,181 filed on Jun. 2, 2006, which are all hereby, in their entirety, herein incorporated by reference.

The paper substrate of the present invention may have any black, cyan, or magenta optical density as measured by TAPPI METH OD T 1213 sp-03 and/or as described in the examples below. The optical density may be from 0.5 to 2.0, more preferably from 1.0 to 1.5. The black optical density may be at least 0.5, 0.6, 0.7, 0.8, 0.9, 1.0, 1.05, 1.06, 1.07, 1.08, 1.09, 1.10, 1.11, 1.12, 1.13, 1.14, 1.15, 1.16, 1.17, 1.18, 1.19, 12, 1.3, 1.4, and 1.5, including any and all ranges and subranges therein. The cyan optical density may be at least 0.5, 0.6, 0.7, 0.8, 0.9, 1.0, 1.05, 1.06, 1.07, 1.08, 1.09, 1.10, 1.11, 1.12, 1.13, 1.14, 1.15, 1.16, 1.17, 1.18, 1.19, 1.2, 1.3, 1.4, and 1.5, including any and all ranges and subranges therein. The magenta optical density may be at least 0.5, 0.6, 0.7, 0.8, 0.9, 1.0, 1.05, 1.06, 1.07, 1.08, 1.09, 1.10, 1.11, 1.12, 1.13, 1.14, 1.15, 1.16, 1.17, 1.18, 1.19, 1.2, 1.3, 1.4, and 1.5, including any and all ranges and subranges therein.

While the paper substrate containing the sizing composition may be used for any use, it is preferable that the such substrate is used for flexographic printing processes. Flexography is a printing process which utilizes a flexible relief plate that can be adhered to a printing cylinder. It is basically an updated version of letterpress. It much more versatile than letterpress in that it can be used for printing on almost any type of substrate including plastic, metallic films, cellophane, and paper. It is widely used for printing on the non-porous substrates required for various types of food packaging. It is also well suited for printing large areas of solid colour.

Flexography continues to be one of the fastest growing print processes and is no longer reserved just for printing specialty items. The ability of flexography to print on a variety of substrates allows the process to be used for a wide range of printed products. Food packaging is an important market because of the ability of flexography to print on non-porous substrates. This ability makes it useful for printing on plastic bags as well. Other common applications printed with flexography include gift wrap, wallcovering, magazines, newspaper inserts, paperback books, telephone directories, and business forms.

The relief plate used for flexography is made of molded rubber or photopolymer materials with the image areas raised above the non-image areas of the plate. Flexographic plates can be created with analog and digital platemaking processes.

Flexography is a direct printing method in that the inked plate applies the image directly to the substrate. An inked roller known as the “anilox roller”, applies ink to the raised portions of the plate which is then transferred to the substrate. The anilox roller has cells that carry a specific amount of ink to the plate. The number of cells per linear inch can vary according to the type of print job and the quality required.

The name “anilox” is derived from the ink that was used for the process until the 1950's. Anilox ink was manufactured with “aniline” dyes which, in the 1950's, were discovered to be health hazards, so pigment based inks were developed and have been used ever since. The ink carrying roller has continued to be called the “anilox roller” even though the aniline dye inks are no longer used for flexography. The current inks are very fluid and dry rapidly and are most often water based.

The present invention also relates to a flexoprinting process that prints upon the surface of the inventive substrate with an pigmented ink composition specifically tailored for flexoprinting. While the pigmented ink may be suspended within any solution, organic or water-based, it is preferred to be present in a water based composition.

While the pigment may have any particle size, it is preferable that the pigment have a particle size that ranges from 1 nm to 15 microns. Preferably, the pigment within the pigmented ink used for flexoprinting has an average particle size that is greater than 300 nm, at least 350 nm, at least 400 nm, and at least than 500 nm. The pigment particle size may be greater than 1, 5, 10, 25, 50, 100, 200, 300, 350, 400, 500, 600, 700, 800, 900, 1000, 5000, 10000, and 15000 nm, including any and all ranges and subrange therein.

In one embodiment, conventional flexoprinting pigment-containing inks may be diluted and printed upon the substrate, yet the substrate can retain the same or better print density as that when conventional substrates are printed with the conventional undiluted flexoprinting pigment-containing inks. The dilution may be at least 1, 2, 3, 4, 5, 6, 7, 8, 9, 10, 11, 12, 13, 14, 15, 16, 17, 18, 19, and 20% based upon the standard concentration of conventional flexoprinting pigment-containing inks, yet the substrate is able to retain the same or better print density as that when conventional substrates are printed with the conventional undiluted flexoprinting pigment-containing inks.

Numerous modifications and variations on the present invention are possible in light of the above teachings. It is, therefore, to be understood that within the scope of the accompanying claims, the invention may be practiced otherwise than as specifically described herein.

As used throughout, ranges are used as a short hand for describing each and every value that is within the range, including all subranges therein.

All of the references, as well as their cited references, cited herein are hereby incorporated by reference with respect to relative portions related to the subject matter of the present invention and all of its embodiments.

### EXAMPLES

### Paper Tested

### Base Grade: 20# Laser MOCR

### Size Press Formulations

| | | | | Calcium |
|---|---|---|---|---|
| | Size Press | Size Press | Starch | Chloride |
| Sizing | Solids | Viscosity | Pick-up | Pick-up |
| Composition | (%) | (cps) | (lb/T) | (lb/T) |
| 1* | 17.0 | 80 | 70 | 15 |
| 2** | 15.0 | 100 | 80 | 0 |
| 3*** | 15.0 | 25 | 70 | 15 |
| 4**** | 13.0 | 25 | 80 | 0 |

*Base paper was made with size press applied starch and calcium chloride to form an I-beam.
**Base paper was made with size press applied starch to form an I-beam.
***Base paper was treated with size press applied Calcium Chloride and starch to form an I-beam.
****Base paper was made with size press applied starch and no Calcium Chloride to form I-beam.

All conditions are on 20 lb/1300 ft2 basis weight/paper using ethylated starch. Base paper was made to standard paper making practices. All papers were made by applying a sizing compositions 1-4 using rods metered size press.

### Flexographic Press Trial

All four sheets were printed on a six print deck flexographic inline press, using two different standard flexographic inks (Fluid inks A & B). The press was equipped with chamber doctor blade ink metering systems. Each deck was printing a 10″×3″ solid strip with the following setup.

| | deck # | | | | | |
|---|---|---|---|---|---|---|
| | 1 | 2 | 3 | 4 | 5 | 6 |
| Color | Cyan | Magenta | Black | Black | Cyan | Magenta |
| Anilox | 500/5.0 | 500/5.0 | 500/5.0 | 500/4.0 | 500/4.0 | 500/4.0 |

Anilox values refer to line (cells per liner inch)/bcm (billion cubic microns). bcm is the cell volume. All anilox rolls were engraved at a 60 degree angle.
Each of the four trial conditions was printed with this setup using both standard inks as shipped, then with both inks diluted 10% by weight with water, then with the inks diluted 20% by weight with water.

| | | | | | | |
|---|---|---|---|---|---|---|
| Fuild Ink A Viscosity | 26 | 26 | 29 | 29 | 26 | 27 |
| Fuild Ink B Viscosity | 25 | 26 | 26 | 26 | 25 | 26 |

Viscosity is measured with a #2 zahn cup.

Inks were diluted by weight with water as follows:

(known ink starting weight/90)*10=weight of water to added to dilute 10%

((known ink starting weight/80)*100)−10% diluted weight=weight of water to added to dilute 20%

The impression pressure for each unit was set for the first roll and not changed throughout the run.
Print optical density was measured on all 24 samples using an X-Rite handheld spectrodensitometer.
Each printing decks image (colour/anilox) on each paper condition was measured 6 times and averaged. The results follow:

| | | | |
|---|---|---|---|
| 1 | 2 | 3 | 4 |

FLUID INK A- Undiluted

| | | | | |
|---|---|---|---|---|
| B500/4.0 | 1.11 | 1.06 | 1.16 | 1.06 |
| B500/5.0 | 1.25 | 1.21 | 1.27 | 1.22 |
| C500/4.0 | 1.14 | 1.12 | 1.17 | 1.12 |
| C500/5.0 | 1.12 | 1.09 | 1.13 | 1.09 |
| M500/4.0 | 1.00 | 0.97 | 1.03 | 0.98 |
| M500/5.0 | 1.10 | 1.06 | 1.14 | 1.06 |

10% diluted Cut

| | | | | |
|---|---|---|---|---|
| B500/4.0 | 1.09 | 1.02 | 1.10 | 1.01 |
| B500/5.0 | 1.21 | 1.17 | 1.24 | 1.18 |
| C500/4.0 | 1.11 | 1.06 | 1.13 | 1.07 |
| C500/5.0 | 1.06 | 1.06 | 1.12 | 1.05 |
| M500/4.0 | 0.97 | 0.95 | 0.98 | 0.93 |
| M500/5.0 | 1.05 | 1.01 | 1.09 | 1.01 |

20% diluted Cut

| | | | | |
|---|---|---|---|---|
| B500/4.0 | 0.98 | 0.98 | 1.03 | 0.98 |
| B500/5.0 | 1.14 | 1.09 | 1.16 | 1.09 |
| C500/4.0 | 1.02 | 1.00 | 1.05 | 1.00 |
| C500/5.0 | 1.02 | 1.00 | 1.05 | 0.99 |
| M500/4.0 | 0.91 | 0.87 | 0.93 | 0.89 |
| M500/5.0 | 0.99 | 0.95 | 1.01 | 0.96 |

| | | | |
|---|---|---|---|
| 1 | 2 | 3 | 4 |

Fluid INK B At start Ink Press Ready

| | | | | |
|---|---|---|---|---|
| B500/4.0 | 1.06 | 1.03 | 1.06 | 1.04 |
| B500/5.0 | 1.21 | 1.18 | 1.21 | 1.18 |
| C500/4.0 | 1.11 | 1.09 | 1.11 | 1.07 |
| C500/5.0 | 1.09 | 1.08 | 1.11 | 0.94 |
| M500/4.0 | 1.02 | 0.98 | 1.00 | 0.98 |
| M500/5.0 | 1.11 | 1.07 | 1.13 | 1.06 |

10% diluted Cut

| | | | | |
|---|---|---|---|---|
| B500/4.0 | 1.00 | 1.00 | 1.07 | 1.01 |
| B500/5.0 | 1.17 | 1.13 | 1.18 | 1.13 |
| C500/4.0 | 1.05 | 1.03 | 1.07 | 1.02 |
| C500/5.0 | 1.01 | 0.99 | 1.04 | 1.00 |
| M500/4.0 | 0.96 | 0.96 | 1.02 | 0.94 |
| M500/5.0 | 1.07 | 1.04 | 1.11 | 1.03 |

20% diluted Cut

| | | | | |
|---|---|---|---|---|
| B500/4.0 | 0.95 | 0.95 | 0.99 | 0.92 |
| B500/5.0 | 1.09 | 1.06 | 1.11 | 1.05 |
| C500/4.0 | 0.96 | 0.96 | 1.00 | 0.94 |
| C500/5.0 | 0.94 | 0.92 | 0.96 | 0.93 |
| M500/4.0 | 0.90 | 0.88 | 0.95 | 0.88 |
| M500/5.0 | 1.00 | 0.97 | 1.05 | 0.98 |

All of the data above are expressed in the Graphs that follow and/or are averaged and then graphed (see the graph heading for clarity). In the tables above, B is defined as Black, C is defined as Cyan, and M is defined as Magenta.

In summary, the present invention is directed to a method of making a printed substrate paper comprising forming an image onto at least one surface of a treated substrate paper using a flexoprinting process. The treated substrate paper comprises a composition comprising lingo cellulosic fibers and a water soluble divalent metal salt. The image is formed with a flexoprinting ink and the flexoprinting ink is a pigmented ink. The pigmented ink has a particle size that ranges from about 1 nm to about 15000 micron. The pigmented ink is diluted prior to forming the image. The dilution is at least 1% to about 20% based upon the standard concentration of conventional flexoprinting pigmented ink. The treated substrate paper exhibits from about 4% to about 5.5% higher optical print density than a non-treated substrate paper. The treated substrate paper printed with a 4.0 volume anilox exhibits at least 5% reduction in optical density vs. a non-treated substrate paper and the treated substrate paper exhibits substantially higher hygroexpansivity in the CD direction when compared to the non-treated substrate paper. The water soluble divalent metal salt is a salt of calcium chloride and the composition further comprises a starch wherein the composition and the starch cooperate to form an I-beam structure. The substrate paper is treated at the size press.

The present invention is also directed to a method of making a printed substrate paper comprising forming an image onto at least one surface of the printed substrate paper using a flexoprinting process. The substrate paper comprising a sizing composition having lingo cellulosic fibers and a water soluble divalent metal salt to form a treated substrate paper wherein the sizing composition contain from 1 to 3 wt % of the divalent metal salt based on the total weight of the solids in the composition.

The present invention is further directed to a method of improving the print quality of a flexo-printed paper substrate comprising flexoprinting an image to a treated paper substrate. The treated substrate comprises a composition comprising lingo cellulosic fibers and a water soluable divalent metal salt to form the image having an improved print quality. The improved print quality is at least 5% to about 10% greater than a print quality of a printed substrate without the composition as measured with black, cyan, or magenta flexoprinting inks according to TAPPI method T-1213 sp 03. The optical density for each of the black, cyan, or magenta flexoprinting inks is from at least 0.5 to 1.5.

Various modifications and variations may be devised given the above-described embodiments of the invention. It is intended that all embodiments and modifications and variations thereof be included within the scope of the invention as it is defined in the following claims.

What is claimed is:

1. A method of making a printed substrate paper, comprising:
forming an image onto at least one surface of a treated substrate paper using a flexoprinting process wherein the treated substrate paper comprises a composition comprising lingo cellulosic fibers and a water soluable divalent metal salt.

2. The method of claim 1 wherein the image is formed with a flexoprinting ink.

3. The method of claim 2 wherein the flexoprinting ink is a pigmented ink.

4. The method of claim 3 wherein the pigmented ink have a particle size that ranges from about 1 nm to about 15000 micron.

5. The method of claim 3 wherein the pigmented ink is diluted prior to forming the image.

6. The method of claim 5 wherein the dilution is at least 1% to about 20% based upon the standard concentration of conventional flexoprinting pigmented ink.

7. The method of claim 1 wherein the treated substrate paper exhibits from about 4% to about 5.5% higher optical print density than a non-treated substrate paper.

8. The method of claim 1 wherein the treated substrate paper printed with a 4.0 volume anilox exhibits at least 5% reduction in optical density vs. a non-treated substrate paper.

9. The method of claim 1 wherein the treated substrate paper exhibits substantially higher hygroexpansivity in the CD direction when compared to the non-treated substrate paper.

10. The method of claim 1 wherein the water soluble divalent metal salt is a salt of calcium or magnesium.

11. The method of claim 10 wherein the water soluble divalent metal salt is a salt of calcium.

12. The method of claim 11 wherein the water soluble divalent metal salt is a salt of calcium chloride.

13. The method of claim 1 wherein the composition further comprises a starch.

14. The method of claim 13 wherein the composition and the starch cooperate to form an I-beam structure.

15. The method of claim 1 wherein the substrate paper is treated at the size press.

16. A method of making a printed substrate paper, comprising:
forming an image onto at least one surface of the printed substrate paper using a flexoprinting process wherein the substrate paper comprising a sizing composition having lingo cellulosic fibers and a water soluble divalent metal salt to form a treated substrate paper wherein the sizing composition contain from 1 to 3 wt % of the divalent metal salt based on the total weight of the solids in the composition.

17. The method of claim 16 wherein the image is printed on a six print deck flexgraphic inline press using two different flexographic inks.

18. The method of claim 17 wherein each of the images on each of the printed substrate paper was measured six times and averaged.

19. A method of improving the print quality of a flexo-printed paper substrate comprising:
flexoprinting an image to a treated paper substrate wherein the treated substrate comprises a composition comprising lingo cellulosic fibers and a water soluable divalent metal salt to form the image having an improved print quality, the improved print quality being at least 5% to about 10% greater than a print quality of a printed substrate without said composition as measured with black, cyan, or magenta flexoprinting inks according to TAPPI method T-1213 sp 03.

20. The method of claim 19 wherein an optical density for each of the black, cyan, or magenta flexoprinting inks is from at least 0.5 to 1.5.
